(19) United States
(12) Patent Application Publication
(10) Pub. No.: US 2016/0189198 A1
(43) Pub. Date: Jun. 30, 2016

(54) AUTOMATED MEDIA CAMPAIGN MANAGEMENT SYSTEM

(71) Applicant: Reelio, Inc., New York, NY (US)

(72) Inventors: Daniel MCKENZIE, Manhattan, NY (US); Peter BORUM, Manhattan, NY (US); Benjamin WILLIAMS, Brooklyn, NY (US); Mark BORUM, Manhattan, NY (US)

(73) Assignee: Reelio, Inc., New York, NY (US)

(21) Appl. No.: 14/586,182

(22) Filed: Dec. 30, 2014

(51) Int. Cl. G06Q 30/02; H04L 29/08

(52) U.S. Cl. CPC G06Q 30/0242; H04L 67/02; G06Q 30/0277; G06Q 30/0276

(57) ABSTRACT

The present disclosure is directed to a system for automatically managing media campaigns. This system can receive media campaign parameters from a user, identify and recruit media content creators to create media for the user's media campaign, and manage and track performance of the created media.

### FIELD OF THE DISCLOSURE

The present disclosure relates generally to automated media campaign management systems. More particularly, the present disclosure relates to an online system for identifying and recruiting media content creators for a user's media campaign, tracking performance of content created by the media content creators, and managing the administration, financial performance, and execution of the user's media campaign.

### BACKGROUND

In today's society, the worlds of online and traditional entertainment (TV, movies, newspaper, etc.) are converging. Traditionally, broadcasting spectrum, infrastructure, equipment, personnel, and marketing all required very high fixed investments. As a result, the entertainment industry has been run by a select few gatekeepers with the necessary political and financial capital. However, internet-enabled TV has been able to reach 40% penetration into the US Broadband market in a very short period of time, creating an opportunity for independents to compete with traditional players on the same platform for the same audience. In addition, high quality production and editing equipment is more affordable than ever and crowdfunding platforms reduce barriers to entry for high-quality independent productions. As internet television becomes commonplace, independent content creators will increasingly have the opportunity to compete for the same audiences as the studios.

Websites such as YouTube, Vimeo, and Dailymotion make it even easier for independent content creators to broadcast their work to a worldwide audience. In fact, there are over 1 billion unique visitors to YouTube each month watching over 6 billion hours of content. In addition, YouTube continues to grow on a daily basis. For example, 50% more hours of video were watched in March 2013 compared to August 2012.

Not only is the YouTube community massive and still growing, but YouTube reaches more US adults ages 18-34 than any cable network. These videos are more than simple entertainment. Instead, YouTube has become more of a social experience. Over 100 million people take social actions (e.g., likes, shares, comments) on YouTube every week. In addition, over 700 YouTube videos are shared on Twitter each minute and more than 50% of videos on YouTube have been rated or include comments from the community. Besides sharing videos to other websites, such as Twitter, Facebook, Reddit, Google+, etc., viewers can subscribe to various YouTube channels, which are essentially a content creator's YouTube homepage that provides access to all videos that the content creator posted to YouTube. Thus, viewers can stay up to date with and monitor their favorite content creator through their channel. There are currently over 50 million YouTube content creators and more join every day.

Despite the size of the YouTube community, advertisers or brands have trouble reaching their target audience through YouTube. Currently advertisers place pre-roll advertisements in front of desired content as a “have-to-watch” mechanism, as opposed to a “choose-to-watch” alternative. However, 94% of all pre-roll ads are skipped. In addition, advertisers have created their own YouTube channels to try to reach their target audiences. However, over 50% of videos published by the top 100 global brands got fewer than 1,000 views.

Accordingly, user generated content is more trusted than other media. In fact, millennials spend an average of 5 hours per day with user generated content. In addition, user generated content is trusted 50% more than other media.

In contrast to pre-roll advertisements, audiences view and engage with branded video content. Branded video content is user generated content that has the support and backing of a brand. Such content is not a traditional advertisement or commercial but is instead original content with the advertisement imbedded in the user generated content. Branded video content gets a 40% engagement rate and 63% of native video advertisements are completed. Thus, advertisement content that the viewers choose to watch is more successful than ads that the viewers are forced to watch.

### SUMMARY

Brands and other advertisers need to reevaluate their advertising campaigns in light of the changes to the online community. Accordingly, a system is needed for advertisers to place their brand at the center of engaging authentic content. The system needs to transform noise and fragmentation into a predictable, scalable, and brand-friendly environment. Furthermore, this system needs to cut through the noise to identify and recruit ideal content partners from the continuously growing hundreds of millions of content creators in order to align the brands with content creators that fit the brands' needs and are already popular among the brands' target audiences.

Typically, an individual or an agency identifies content creators for an entity, determines how much to pay each creator, determines the type of agreement between the content creator and the entity, negotiates the legal contracts, and manages the creating process from start to finish. Each of these steps requires expertise, time, and additional expense.

Applicants have discovered an automated system for managing a media campaign. The system can receive parameters from a user for creating media content and identify media content creators that meet the user's requirements including having an audience which aligns with a target audience for the user's media content. In addition, the system can contact at least one of the identified media content creators and receive approval from the contacted media content creator to create the media content in accordance with at least one of the received parameters for creating the media content. The system can also receive the created media content and approval from the user to publish the created media content before the media content is publicly available, thereby facilitating the approval interactions between the user and the media content creators. Furthermore, the system can monitor and track the performance of the published media content.

### BRIEF DESCRIPTION OF THE DRAWINGS

FIG. 1 illustrates an example of a computer-implemented method for automating the management of a media campaign.

FIG. 2 illustrates an example of a content creator identification process within an embodiment of the media management system.

FIG. 3 illustrates an example of a media creation process within an embodiment of the media management system.

FIG. 4 illustrates an example user interface for receiving campaign parameters to create a media campaign.

FIG. 5 illustrates an example user interface for receiving campaign parameters including the campaign's submission deadline and minimum subscribers.

FIG. 6 illustrates an example user interface for receiving campaign parameters including specifying the type of media format.

FIG. 7 illustrates an example user interface for receiving campaign parameters including a user's assets.

FIG. 8 illustrates an example user interface displaying a summary of campaign parameters.

FIG. 9 illustrates an example user interface for searching for content creators.

FIG. 10 illustrates an example user interface displaying content creator search results.

FIG. 11 illustrates an example user interface expanding on an individual content creator in the content creator search results.

FIG. 12 illustrates an example user interface for filtering content creator search results.

FIG. 13 illustrates an example user interface for adding a content creator as a candidate for a media campaign.

FIG. 14 illustrates an example user interface for contacting a content creator with a message.

FIG. 15 illustrates an example user interface for contacting a content creator with a contract.

FIG. 16 illustrates an example user interface for contacting a content creator with campaign parameters.

FIG. 17 illustrates an example user interface for receiving a message from a user.

FIG. 18 illustrates an example user interface for accepting or rejecting to join a media campaign.

FIG. 19 illustrates an example user interface for receiving media content from the content creator.

FIG. 20 illustrates an example user interface providing notification of media content submission.

FIG. 21 illustrates an example user interface for approving media content.

FIG. 22 illustrates an example user interface for displaying media content approval.

FIG. 23 illustrates an example user interface for publishing media content.

FIG. 24 illustrates an example user interface displaying content creator search results and search history.

FIG. 25 illustrates an example user interface displaying refined search results based on similarity of content creators.

FIG. 26 illustrates an example user interface displaying various media campaign metrics.

FIG. 27 illustrates an example user interface displaying comments on the media content from a media campaign.

FIG. 28 illustrates an example user interface displaying various recruits for a media campaign.

FIG. 29 illustrates an example user interface displaying various media campaign opportunities.

FIG. 30 illustrates an example user interface for applying to a user's media campaign.

### DETAILED DESCRIPTION

The present disclosure is directed to a system for automating the development and management of a media campaign. This system can receive media campaign parameters from a user, identify and recruit media (and receive direct applications from) content creators to create media for the user's media campaign, and manage and track performance of the created media. Media content can be, for example, videos, written articles, blogs, music, or other similar content. This media content can be used for a user's media advertising campaign.

Users of the media development and management system can include brands, advertisers, advertising agencies, individuals, companies, etc. In addition, a user can be how an entity (person, company, etc.) is identified in the system, such as a registered tag, username, email, profile, etc. For example, a media content creator can self-register in the system by completing a user profile that further describes the media content they produce, the industry verticals to which such media content may be relevant, the size and demographic attributes of their audience, their fees and production schedules for producing media content, and any other information that might enable other users of the system to more easily identify and recruit the media content creator to create media content for such users' media campaigns. This information can then be analyzed by the media campaign management system, with specific reference to the campaign parameters of a user's media campaign, to automatically identify media content creators that are relevant to the user's media campaign or desired media content.

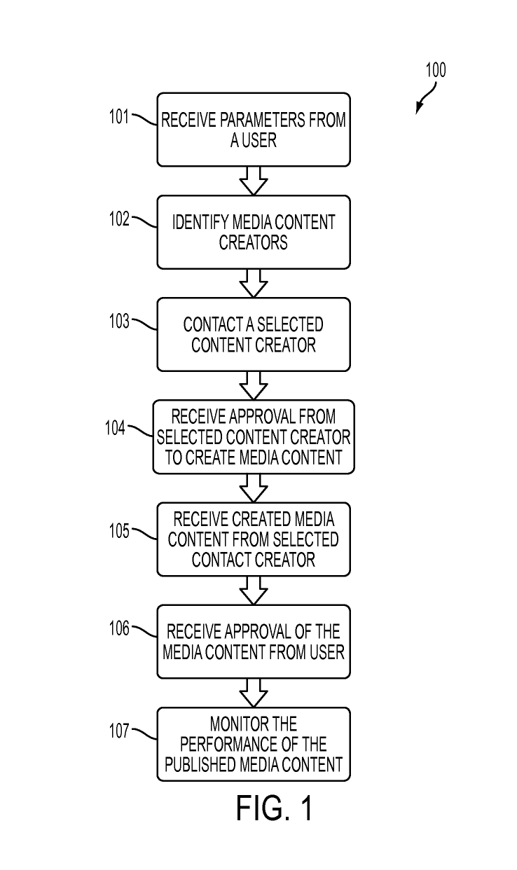

FIG. 1 illustrates an example of computer-implemented method 100 for developing and managing a media campaign. In addition, this method can be performed by an online system. All steps of this method can be automated so as to minimize amount of work and time spent by a user of the system. Automating a step can refer to a user selecting or clicking a button or option for the step to be completed. Accordingly, the user may not have to manually input specific written information into the system during various steps of media campaign development and management processes.

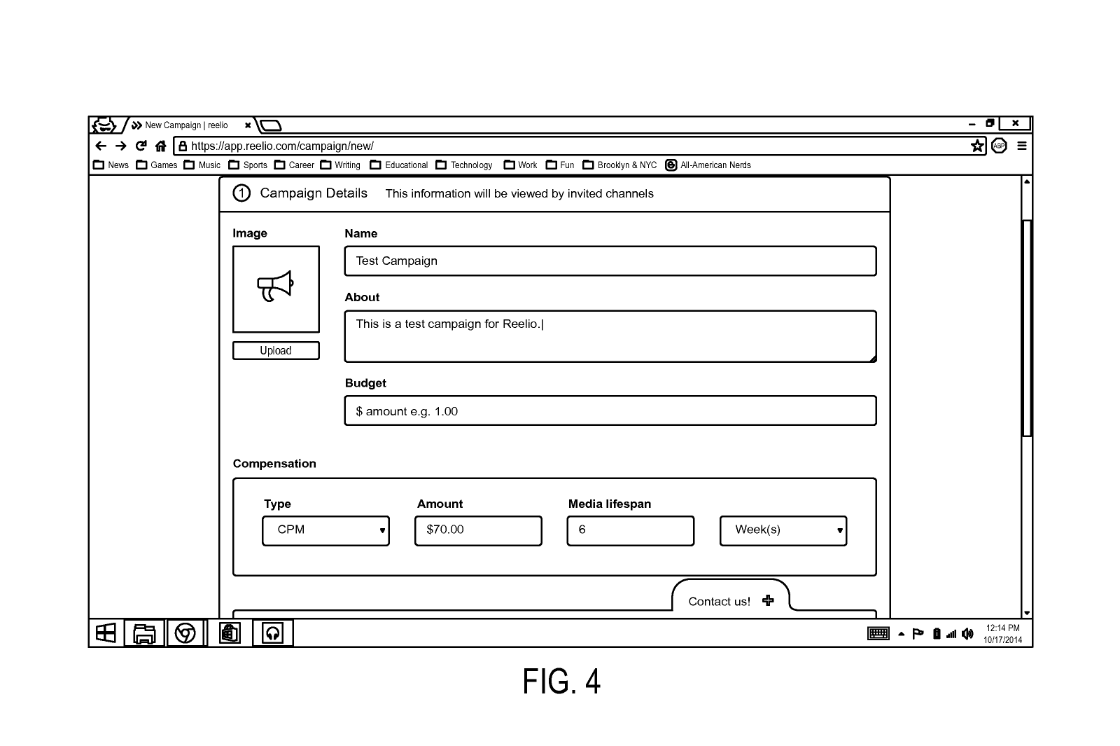

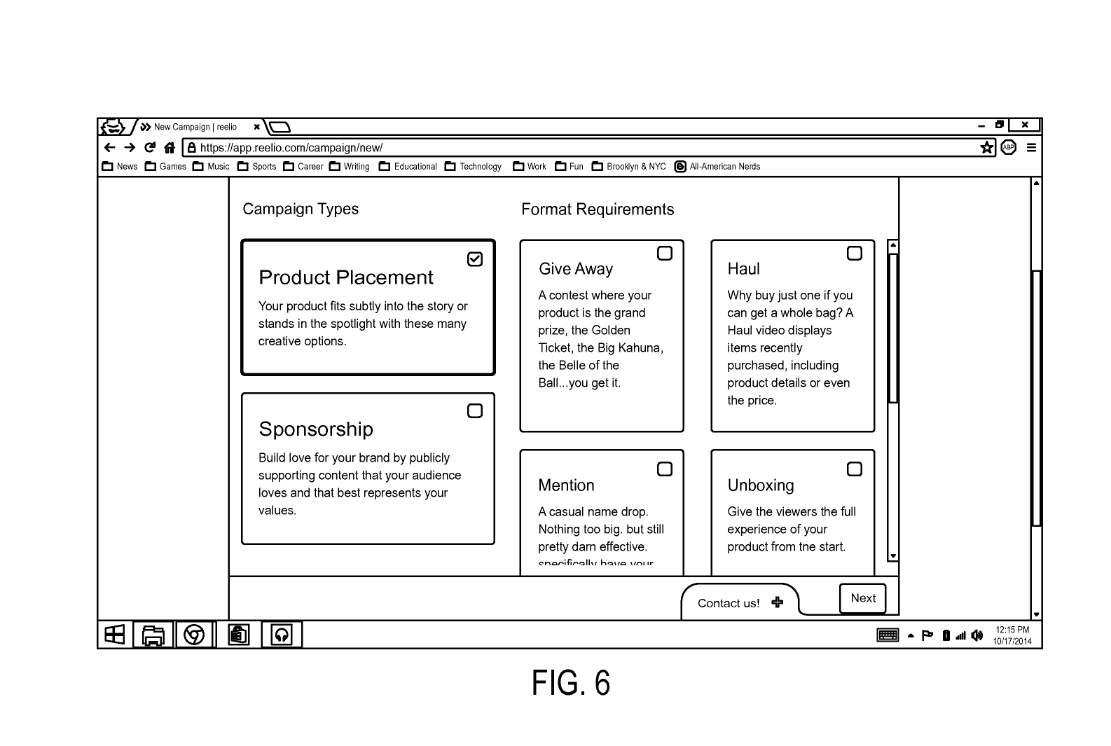

At step 101, the media campaign management system receives parameters for a user's media campaign. Such a media campaign can be for creating specific media content for a user. FIG. 4 illustrates an example user interface for receiving campaign parameters to create a media campaign. The parameters can include the specific type of media format that the user desires to be created. These media formats can include sponsored content, product placements, “how to” content or a tutorial, “unboxing” content, or even custom content. FIG. 6 illustrates an example user interface for receiving campaign parameters including specifying the type of media format. In addition, the media could have already been created by a content creator and the user is looking to repurpose the created media content.

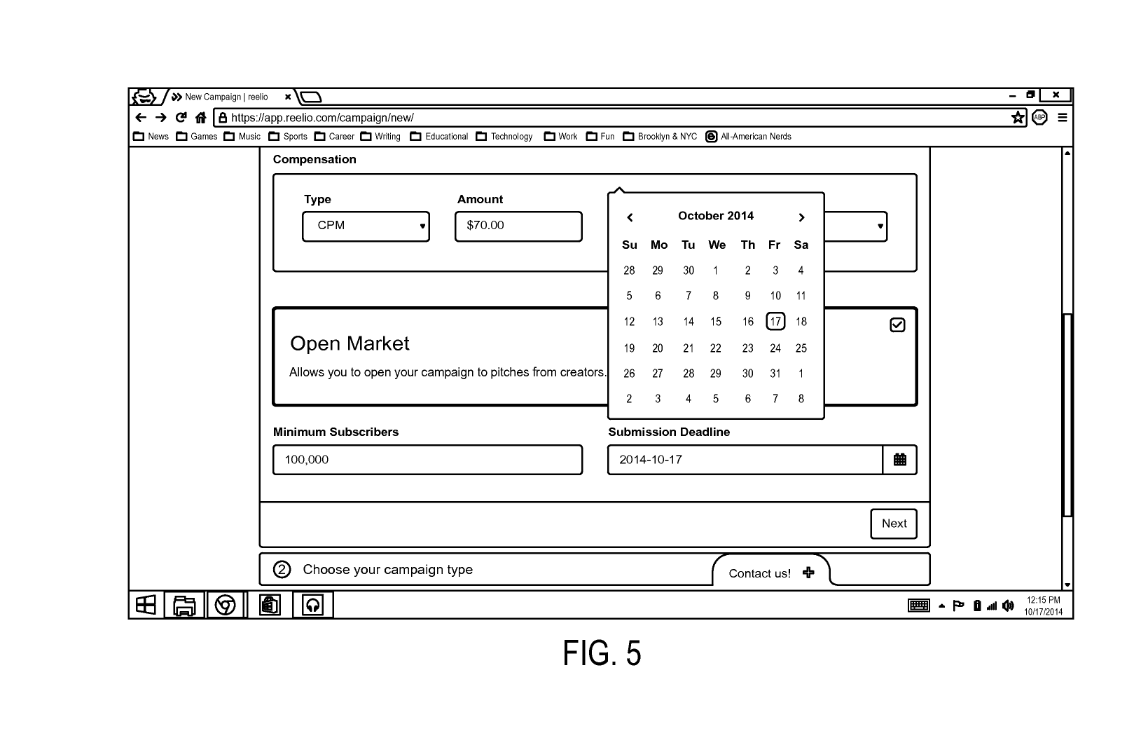

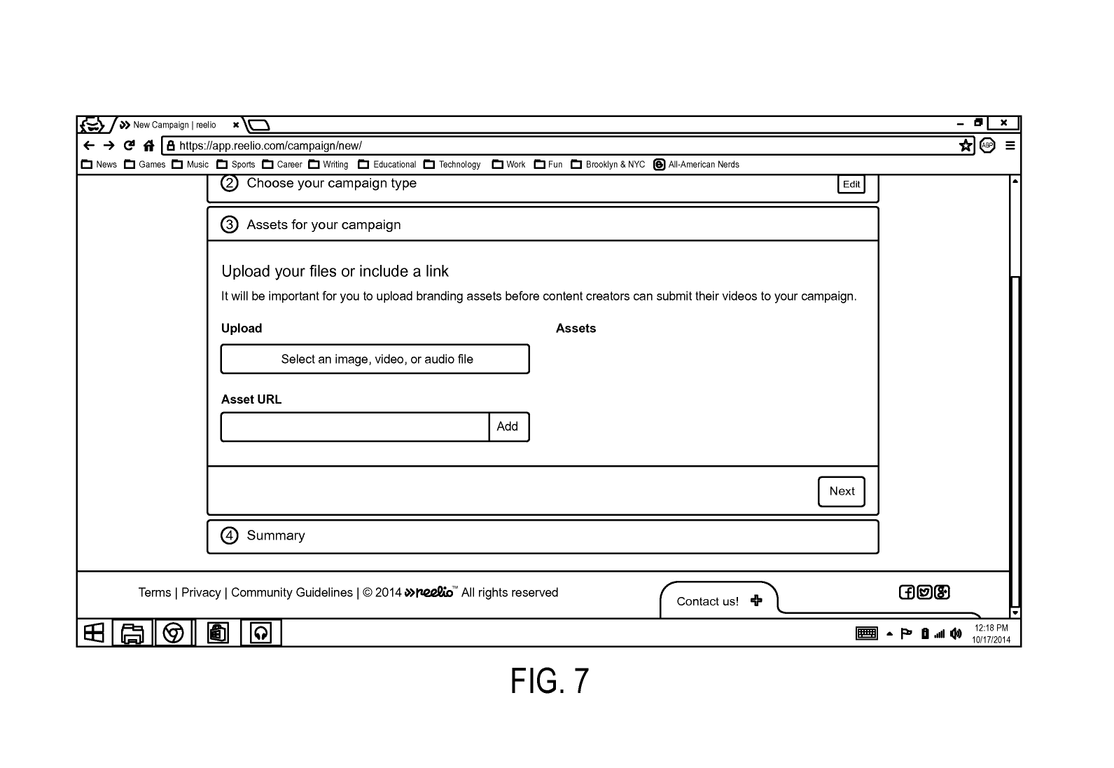

The parameters can also include specific details or requirements regarding the budget of the campaign, creative brief, the call to action, target audience, any of the user's assets that the user wants in the content—such as data, logo, etc.—or any other information from the user to further define the campaign or media content. FIG. 5 illustrates an example user interface for receiving campaign parameters including the campaign's budget. FIG. 7 illustrates an example user interface for receiving campaign parameters including a user's assets. A “creative brief” can either refer to high level concepts that a user wants the created media to feature, highlight, and/or promote or it can refer to a brief description submitted by a content creator in response to a campaign invitation that details the basic creative concept that the media campaign and content may include.

Additional parameters can include a user's media campaign goals. Such goals can include the sought after number of views or impressions, number of comments, demographics, quality of content, size of audience, etc. for the media content. Users can also specify keywords via the system which, if mentioned or referenced in written comments made by viewers of the media content, will be automatically identified by the system so that the user will be alerted to the specific comment(s) that include the specified keywords or terms. For example, a user may specify the name of their company or brand as a keyword for this purpose. As such, the user can receive automatic notification every time a comment is made concerning the relevant media content that includes the company's name or brand name.

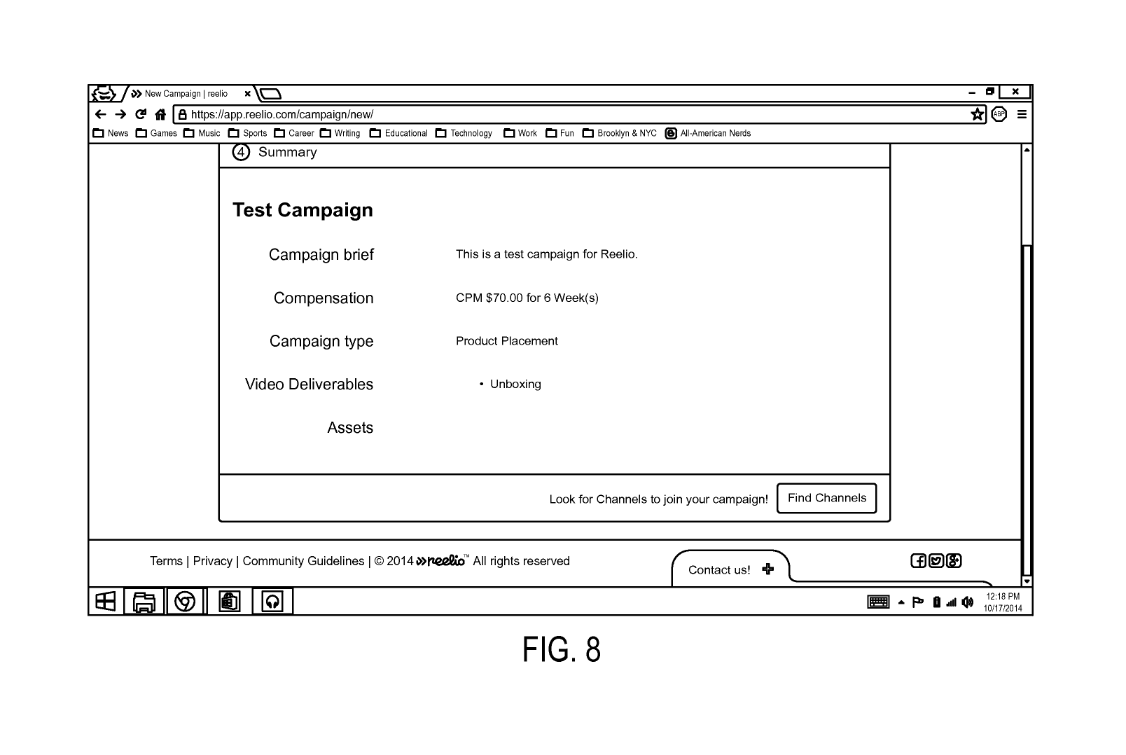

The parameters can be received from the user in various ways. The parameters can be presented as a predefined package recommended by the system. Such predefined packages may be useful for users desiring simplicity or alacrity. In addition, some of the individual parameters can be presented to the user in pre-configured format (i.e., a la carte), wherein the user only has to select or click on desired parameters. Furthermore, some of the parameters can be presented to the user as scroll lists and/or as fill-in the blanks. In addition, any of these parameters can be modified or customized by the user. Once the system has received all the parameters, the system can provide the user with a summary of all the received parameters. FIG. 8 illustrates an example user interface displaying a summary of campaign parameters.

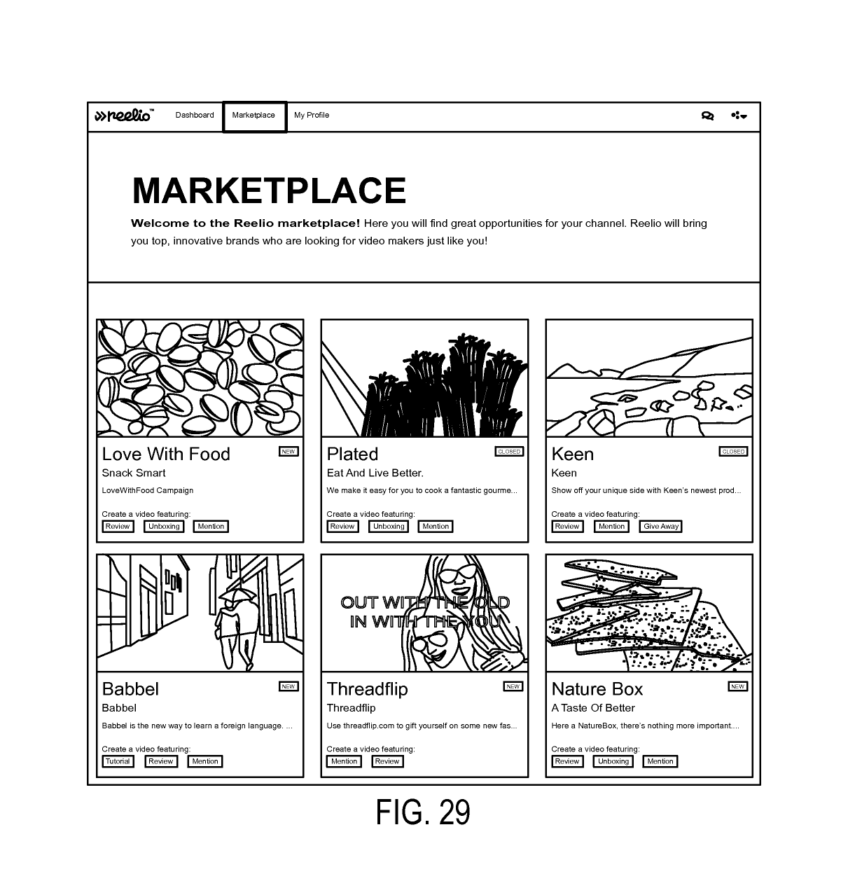

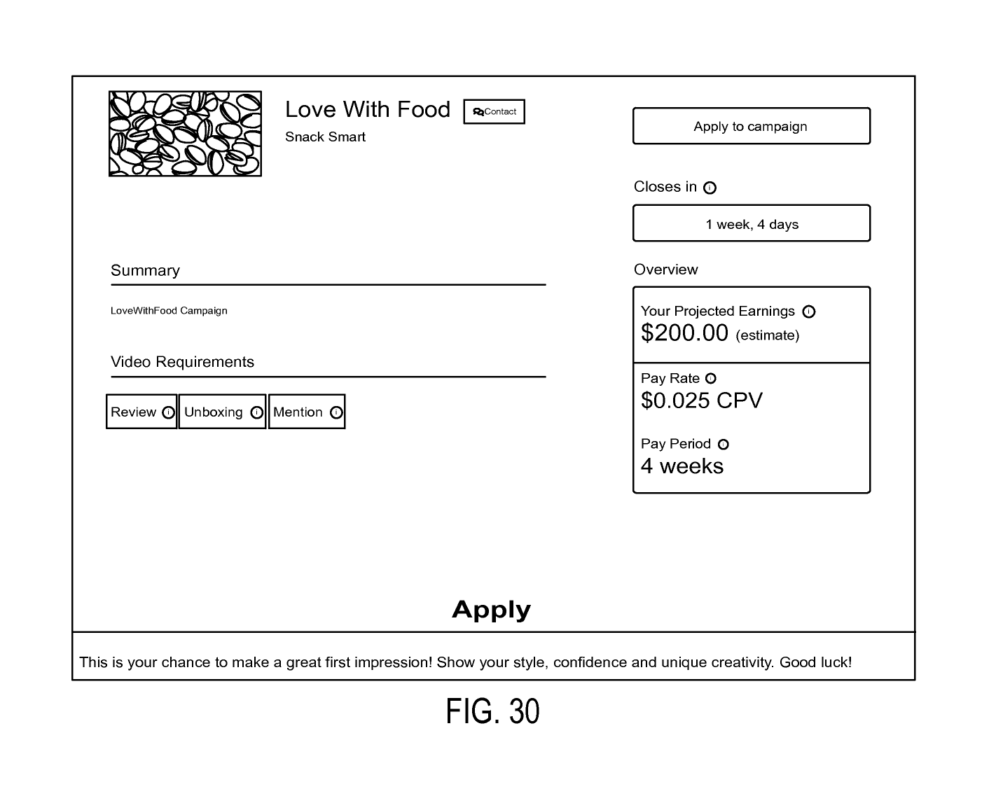

Furthermore, the user may be given the option to post the media campaign parameters to a digital bulletin board or “Open Marketplace” which can be visible to media content creators who are registered in the media campaign management system. The system's Open Marketplace can enable registered media content creators to search, browse, or review media campaign opportunities posted by users initiating such campaigns. FIG. 29 illustrates an example user interface displaying various media campaign opportunities. In addition, the system's Open Marketplace can enable registered media content creators to submit applications to become participants in a user's media campaign. FIG. 30 illustrates an example user interface for applying to a user's media campaign. In applying for such media campaign opportunities posted in the Open Marketplace, the system can permit media content creators to include, inter alia, a creative brief or conceptual pitch for the media content to be produced for the media campaign. The system can also enable users who posted the media campaign opportunity to review this information prior to approving the media content creator's application to participate in the media campaign. Additionally, depending on a user's preferences, the system can use the campaign parameters specified by the user to determine whether all media content creators registered in the system may apply to participate in the media campaign, or whether only a certain subset of such media content creators may apply. This subset of the media content creators can be based upon the Match Score (discussed in detail below) of each media content creator in relation to the campaign parameters. The campaign media management system can also establish individual pricing levels for participation of each media content creator applying to a media campaign opportunity based upon specific characteristics of each media content creator, including, but not limited to, the number of individuals who “follow” or “subscribe” to receive the media content creator's media content. For example, a media content creator with a greater number of subscribers may automatically receive higher pricing than a media content creator who has fewer subscribers.

At step 102, the media campaign management system can identify media content creators for creating media content. The identified media content creator can be identified using a YouTube channel or other media outlet such as Vimeo, Instagram, and Twitter among others. These content creators can be identified to specifically create media for the user's media campaign or for other media partnerships across multiple platforms. In order for a media campaign to be most successful, the audience of the identified content creator should align with the target audience of the user's media campaign or the target audience for the media content. Thus, based on the received campaign parameters, the media campaign management system can automatically identify media content creators that are relevant to the user's media campaign or desired media content so that the desired alignment can be achieved. The system can use social media and demographic metrics to identify content creators with a higher chance of fulfilling a user's media campaign and content needs. Furthermore, the system can allow the user to evaluate recommended content creators. The system can then use these evaluations to improve the quality of recommendations provided to the user.

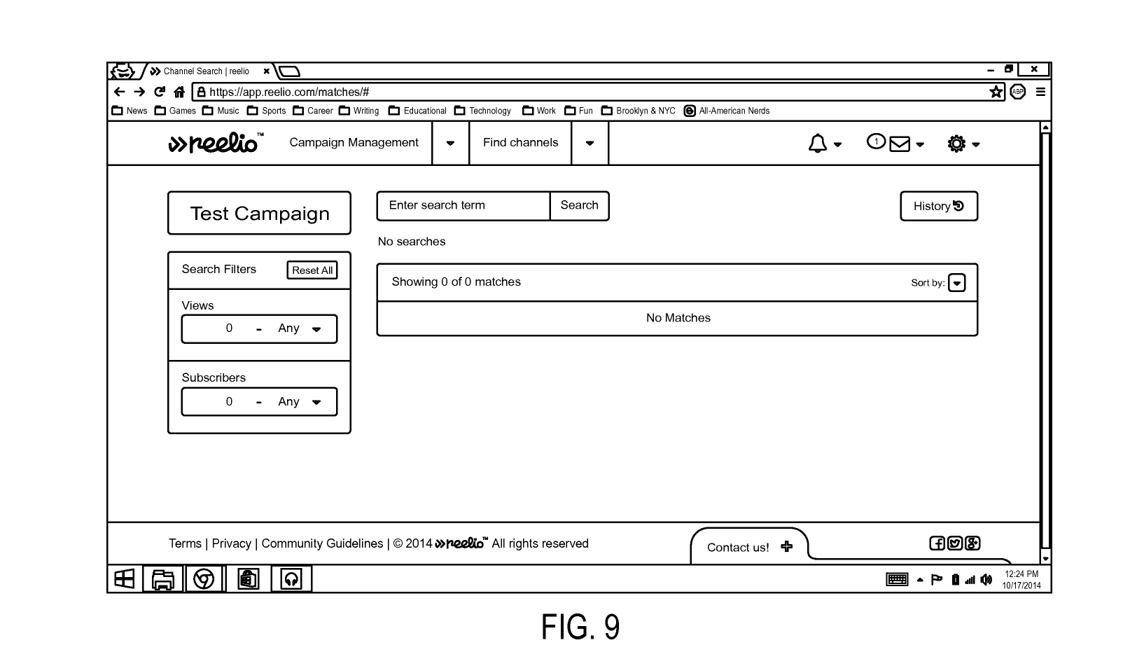

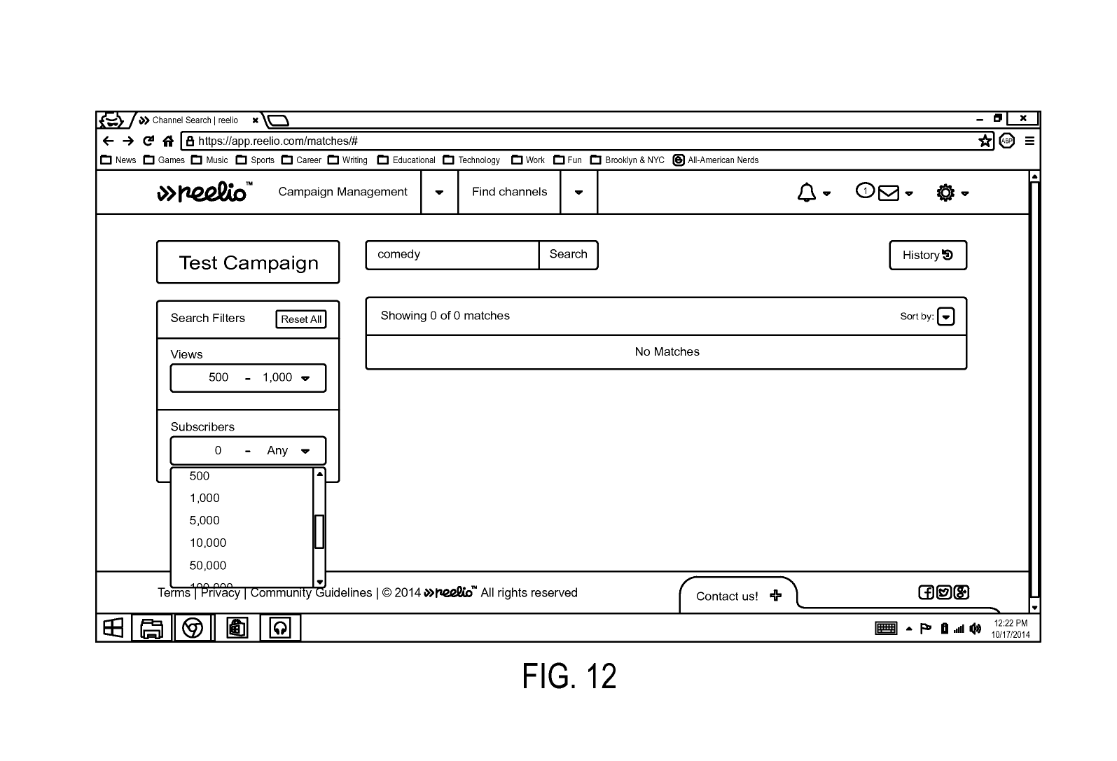

To help identify appropriate content creators, a user can input keywords, social media accounts, categories, and/or YouTube video URLs into the media campaign management system in order to find potential media content creators that are relevant to the user's media campaign and desired media content. FIG. 9 illustrates an example user interface for searching for content creators. In addition to keywords, social media accounts, categories, and/or YouTube video URLs, a user can set limitations, requirements, criteria, or filters to be used when searching for content creators. For example, the user can filter content creator search results based on views, subscribers, average view percentage, likes, comments, demographics, and many other criteria. FIG. 12 illustrates an example user interface for filtering content creator search results.

The management system can simultaneously search multiple outlets. A single content creator may distribute content through various outlets (YouTube, Instagram, FaceBook, Vimeo, Twitter, etc.) and each outlet associated with the creator can provide a slightly different part of the identity of that creator. Twitter has lots of text, NLP, and sentiment analysis capabilities, whereas FaceBook can derive a more in depth picture of the demographics (sex, language, geography, etc.) of the content creator's audience. In addition, YouTube provides more direct performance numbers, but it is difficult to derive more information from video content since there is no text.

Many factors go into identifying content creators that are relevant to the user and/or the user's media campaigns. For example, user inputted keywords and user search history can be used to identify large amounts of creators by establishing topical relevance; twitter handles can be used to identify and categorize creators by topics of expertise, audience attributes, direct audience overlap, sentiment analysis, tagging, and NLP; user inputted video URLs can be used to identify relevant or similar creators using video and social media platform APIs; user approvals/rejections can allow Machine Learning (ML) algorithms to find implicit user preferences to select better content creators for users' media campaigns as well as to improve the accuracy and weighting of all component factors in the algorithm that identifies the relevant content creators; twitter audience data and YouTube API data can be used to derive insight into a content creator's audience; NLP can be used to parse topicality from a user's site to identify content creators who are relevant to the content of the user's site; and a user specific “match quality” score for each content creator can assess and represent how good of a match each creator is for the campaign and can be used to aid in selection or curation of a content creator for a given campaign. In addition, a user's search history can affect the identified content creators.

The media campaign management system can identify appropriate content creators for a given user by comparing a user's social media accounts for direct audience overlap to a content creator's audience or similarity between a user's target media campaign audience and a content creator's audience. In addition, the similarity of the conversations between the user's target audience and the content creator's audience can help identify appropriate content creators.

In addition, the media campaign management system can employ random seeding to prevent population homogeneity in the content creator identification process. While performing a search for an appropriate content creator, the system can inject random and/or unrelated content creators into the search results. By injecting random content creators into the search results, the freshness of the results can be maintained as well as unknown and/or up-and-coming content creators can be identified that might be relevant to the user.

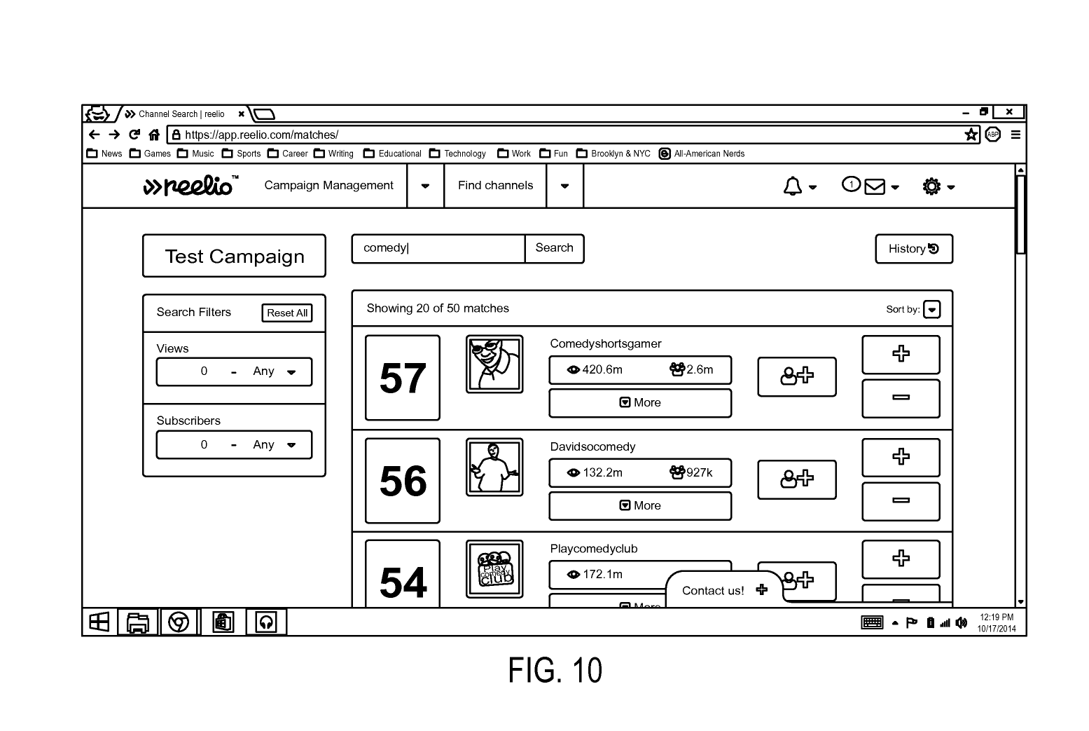

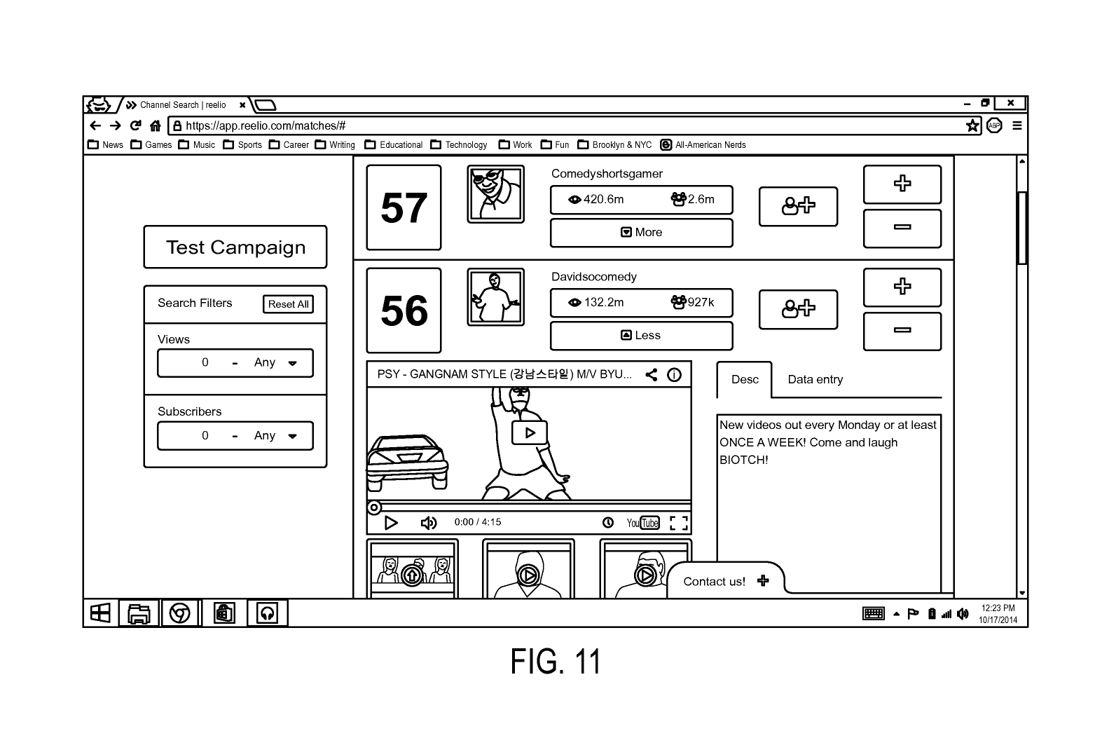

The identified content creators can be displayed to the user in list form. FIG. 10 illustrates an example user interface displaying content creator search results. The displayed content creators may also include individual information on each content creator. FIG. 11 illustrates an example user interface displaying expanding on an individual content creator in the content creator search results. For example, each displayed content creator can include their “Match Score”, amount of views, amount of subscribers, amount of likes, amount of comments, other performance information, audience demographics, example media content, their most popular media content, and other individual content creator information. Selecting an individual content creator from the identified content creators can cause any of the above information of the individual content creator to be displayed.

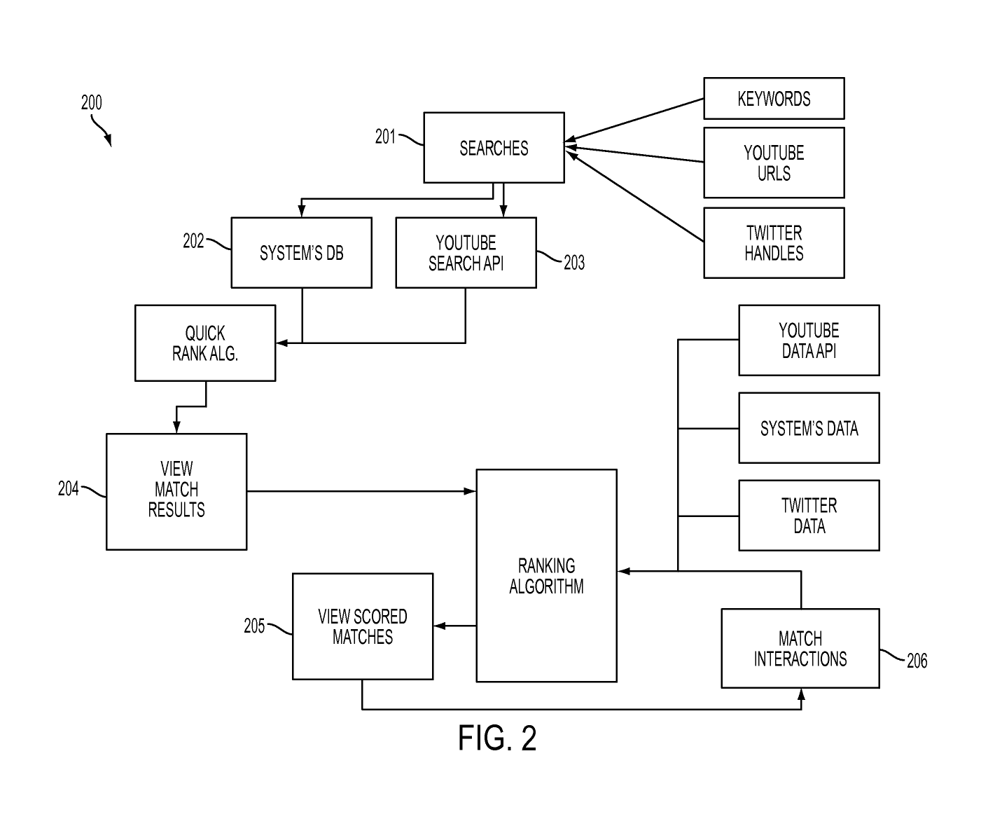

FIG. 2 illustrates an example of a content creator identification process (200) within an embodiment of the media management system. A search (201) can be performed using user input within the system's database (202) to identify relevant content creators. In addition, a search can be performed through the YouTube search API (203) and/or through the APIs of other social media platforms to return more content creators that might not have been retrieved from YouTube or the system's database previously.

The system can analyze each content creator based on dozens of individual judgments called “Base Scores.” All “Scores” can be float values between 0 and 100, where 100 indicates a strong match between a content creator and a user's needs or highly relevant content creator for a given user's needs and 0 indicates a weak match between a content creator and a user's needs or an irrelevant content creator for a given user's needs. The Base Scores can generally be grouped by using four characteristics of a match between content creators and users: (1) “Performance”; (2) “Relevance”; (3) “Audience”; and (4) “Brand Friendliness.” Each of these general characteristics can be further broken down into more specific characteristics or base scores.

For example, the “Performance” type base scores can take into account a subscribers base score (i.e., number of subscribers to a content creator), a viewers base score (i.e., number of unique viewers of a content creator), a latest media content base score (i.e., number of most recent media content posted by a content creator), a days since last media content base score (i.e., number of days since most recent media content posted by a content creator), an engagements base score (i.e., total number of comments, likes, dislikes, favorites, shares, etc. for a content creator's media content), a views base score (i.e., number of views of media content for a content creator), and a latest views base score (i.e., number of views of most recent media content posted by a content creator) among others.

The “Relevance” base score can take into account a search channel base score (i.e., overlap and similarity between user search input and a content creator's or content creator channel's title and description), a search twitter base score (i.e., overlap and similarity between user search input and a content creator's Twitter account including tweets), a search media content base score (i.e., overlap and similarity between user search input and a content creator's media content's titles and descriptions), a twitter base score (i.e., overlap and similarity between a user's Twitter account including tweets and a content creator's or content creator channel's title/description and Twitter account including tweets), and a campaign description media content base score (i.e., overlap and similarity between a user's campaign parameters and a content creator's or content creator channel's title/description and media content's titles and descriptions) among others.

The “Audience” base score can take into account YouTube demographics similarity (comparing a channel's age/sex/geography/etc. to the target demographics for a campaign), language overlap (% of audience speaking/writing the campaign's target language), geographic similarity (based on the system's internal data or YouTube-generated data), a Twitter audience overlap base score (i.e., percent of content creator's or content creator channel's Twitter followers that overlap with a user's Twitter followers), a Twitter language overlap base score (i.e., percent of content creator's or content creator channel's Twitter followers that posted tweets in languages the user is interested in), and a Twitter location overlap base score (i.e., percent of content creator's or content creator channel's Twitter followers that posted tweets in locations the user is interested in) among others. Peripherally, the score can also take into account all of the “Relevance” type base scores applied across the two audiences (the target audience for the campaign and the content creator's audience).

The “Brand Friendliness” base score can take into account a campaign reachout base score (i.e., number of media campaigns the content creator was asked to participate within the system), a message per campaign base score (i.e., number of messages the content creator sent to a user per campaign the content creator participated in in the system), creator description base score (i.e., quality of content creator's description of his published media content on various outlets and/or in the system), message response base score (i.e., content creator's response time to users' messages when participating in a campaign in the system), reachability base score (i.e., ability to contact content creator including whether the content creator provided an email address on various outlets and/or in the system).

Each base score can be mapped to the interval [0,100] based on any desired ranking for determining what constitutes a score of 0, a score of 50, and/or a score of 100 for a given characteristic or base score. The “Base Score” can then be calculated by a weighted average of all the individual base score for a given content creator.

The Base Scores of content creators can then be used in combination with user evaluations of and interactions with content creators identified by the system (e.g., media curation and related approval or disapproval, messages sent by the user to creators from the system, and/or agreements that have actually been entered via the system) to feed into a ML algorithm that will calculate the Match Score.

The system can then bulk-rank the collection of content creators returned from the searches according to the Match Scores. The Match Score can indicate the “quality” of a match between a user's demands and a content creator. In addition, the “Match Score” for a given content creator can be adjusted based on a user's interactions with the various content creators and content creator matches (get more like it, dislike/remove, send message to, etc). The first set of content creator matches (204) can be returned and scored quickly to allow users to start viewing search results immediately. In the background, hundreds more results can be retrieved and a more in-depth analysis can be performed on these results to gain greater insights. These background results can be built up in a queue and can be available to the user, if the user chooses to view more available matches. The system can also use the underlying data on which the Match Score is itself based to predict the likely performance of any media that is produced and published within a media campaign (e.g., the number of impressions such media is likely to achieve after publication) as well as the appropriate rate, cost, or appropriate amount of compensation for a given transaction between a user and a content creator within the context of a media campaign. These predictions can take into account time-weighted past performance, existing agreements and pricing information based upon data generated from transactions occurring on or data otherwise stored in the system, and/or instantaneously derived trends in many of the foregoing data points and attributes. These predictions can be used by the system to entirely automate the pricing and compensation processes of a media campaign.

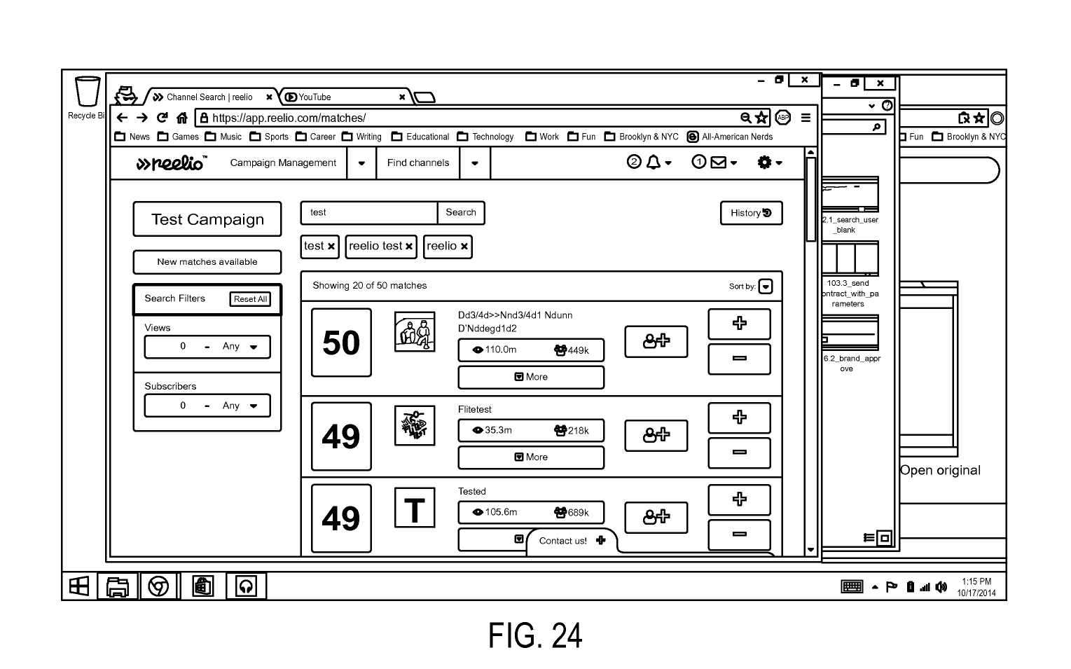

If the user chooses to view more available matches, the visible “active” matches list can be integrated with all the matches generated in the background to build a more comprehensive list of matches for the user to interact with. This comprehensive list of matches (205) can then be visually rendered to the user in order for the user to see the total score, group score, top video, performance information, and other information from each found content creator. FIG. 24 illustrates an example user interface displaying content creator search results and search history.

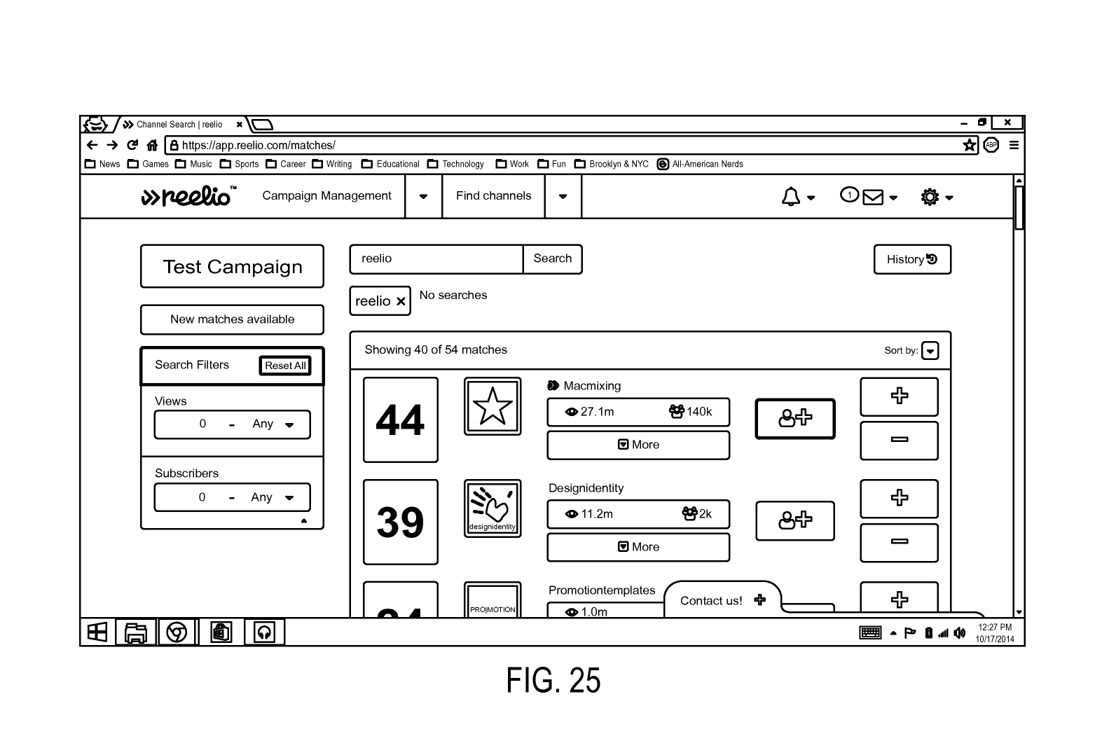

The user can then interact with (206) individual creator results to refine the search in order to find additional content creators similar to the selected creator or less similar to the selected content creator. FIG. 25 illustrates an example user interface displaying refined search results based on similarity of content creators. In addition, adding a new candidate content creator can affect the search for additional content creators. If a user wants more search results like a selected content creator, a positive indicator can be recorded in the media campaign management system and such indicator can influence a higher rank from the Machine Learning algorithm based on the attributes associated with the selected content creator. In addition, this can also trigger retrieval of more content creators similar to the selected content creator. If a user wants less search results like a selected content creator, a negative indicator can be recorded in the media campaign management system and such indicator can reduce the rank from the Machine Learning algorithm based on attributes associated with the selected content creator. In addition, this can also trigger retrieval of more content creators less similar to the selected content creator. Besides Machine Learning algorithms, the system can employ training sets developed internally as well as publically available sets such as those from Google to improve performance of the system.

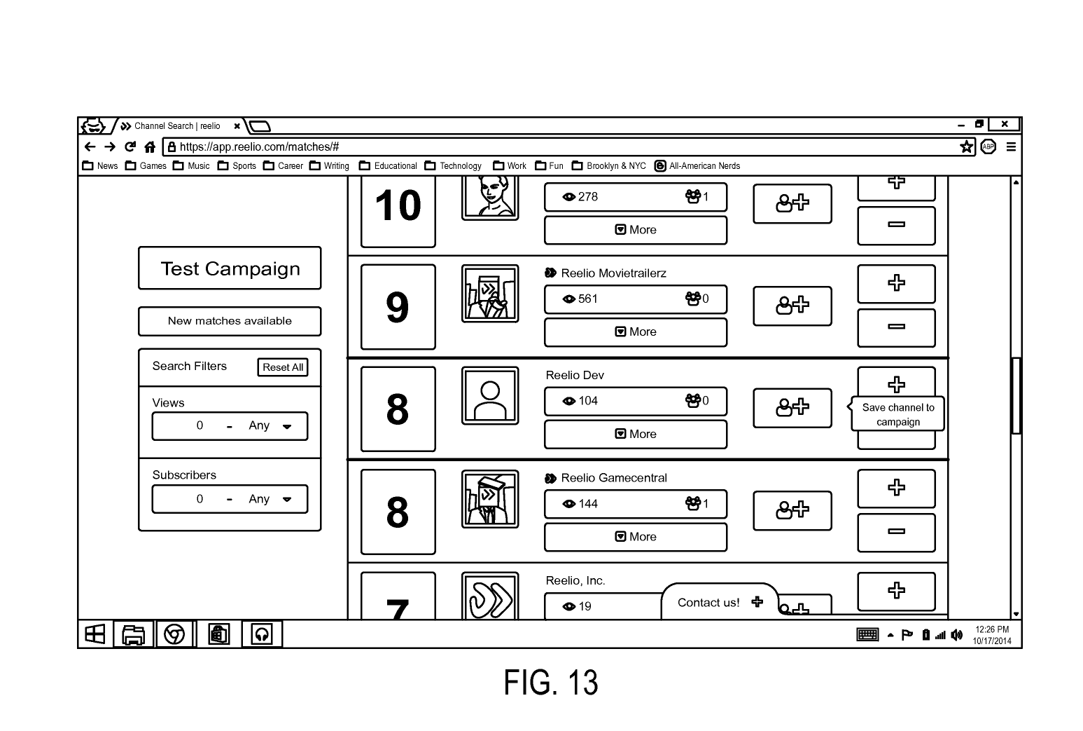

In addition, a user can select an individual content creator to add them to a list of candidates that the user potentially sees itself working with in a media campaign. FIG. 13 illustrates an example user interface for adding a content creator as a candidate for a media campaign.

Additionally, the system can provide automation and optimization of each of these steps where the user can perform an action. When given bounds or constraints for the campaign (including, but not limited to, total budget, overall views goal, number of videos desired, etc.), the system can automatically select the subset of results (creators and/or channels) that best satisfy those constraints. The system can then either provide those results to the user or commence the next step in the media campaign development and management process (user-drive versus automated). When identifying potential content creators and/or selecting content creators, the system can take into account the likelihood that they will respond to or accept an invitation to join a campaign, the size of their audience, their relevance, and many other factors to give the user an optimal number of content creators, thereby minimizing a user's time spent on curation and managing the campaign. In addition, the system can provide and/or select the optimized portfolio of content creators that will maximize views and engagement while minimizing costs to obtain those goals. This can directly tie in with the automated pricing system that underpins the marketplace.

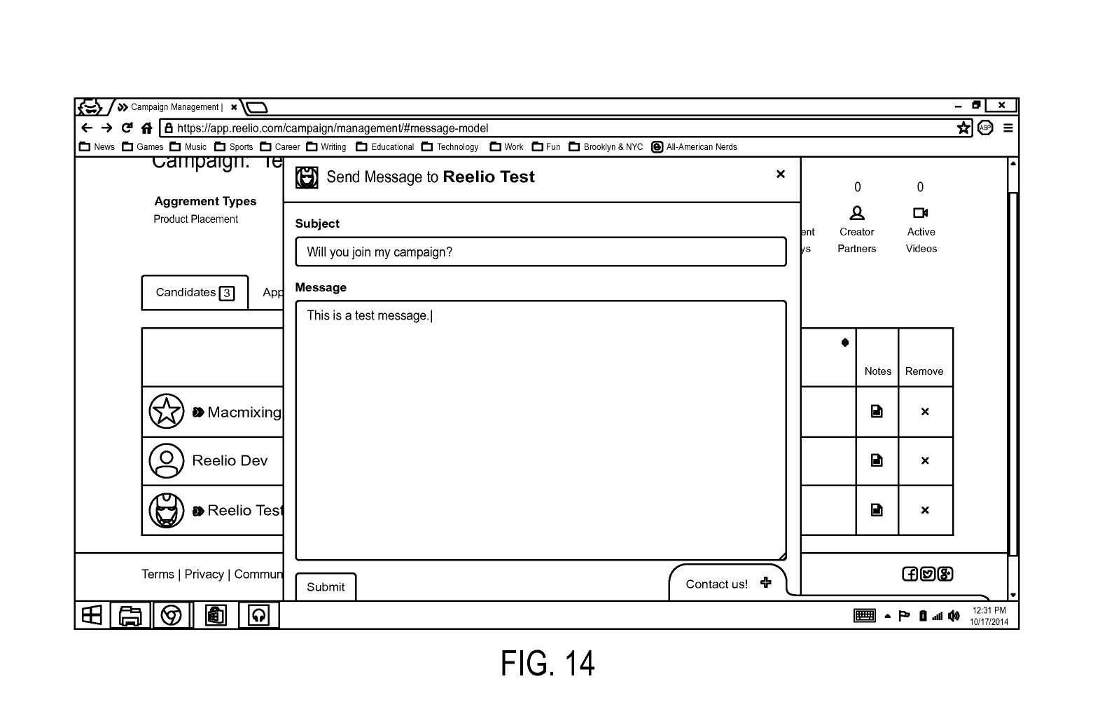

At step 103, the media campaign management system contacts a content creator selected by a user. This media campaign management system can also contact the content creator's agent or manager as discussed below. This contact, for example, can be an invitation to join the media campaign management system, an invitation to join the user's media campaign, an invitation to create media content for a user, and/or a message from the user to the content creator. FIG. 14 illustrates an example user interface for contacting a content creator with a message. In addition, this contact can be the start of a conversation or negotiation to recruit the content creator to join the user's media campaign and/or create media content for the user. For example, this contact can be the user asking the content creator to create new media or use currently existing media for the user's media campaign. This contact can be pre-defined and/or automated such that the user simply has to select to contact a content creator or select to contact multiple content creators and the system can send a predefined message and/or invitation which is automatically personalized to each individual content creator to whom a message and/or invitation is sent. Additionally, the system may automatically send subsequent follow-up messages and/or invitation reminders to content creators if they have not responded to a previously sent message and/or invitation. The ability to send personalized messages and/or invitations from the system to multiple content creators, to detect non-response from content creators receiving those messages and/or invitations, and to automatically send subsequent messages and/or invitation reminders can save the user significant time and effort by essentially automating a critical component of executing media campaigns.

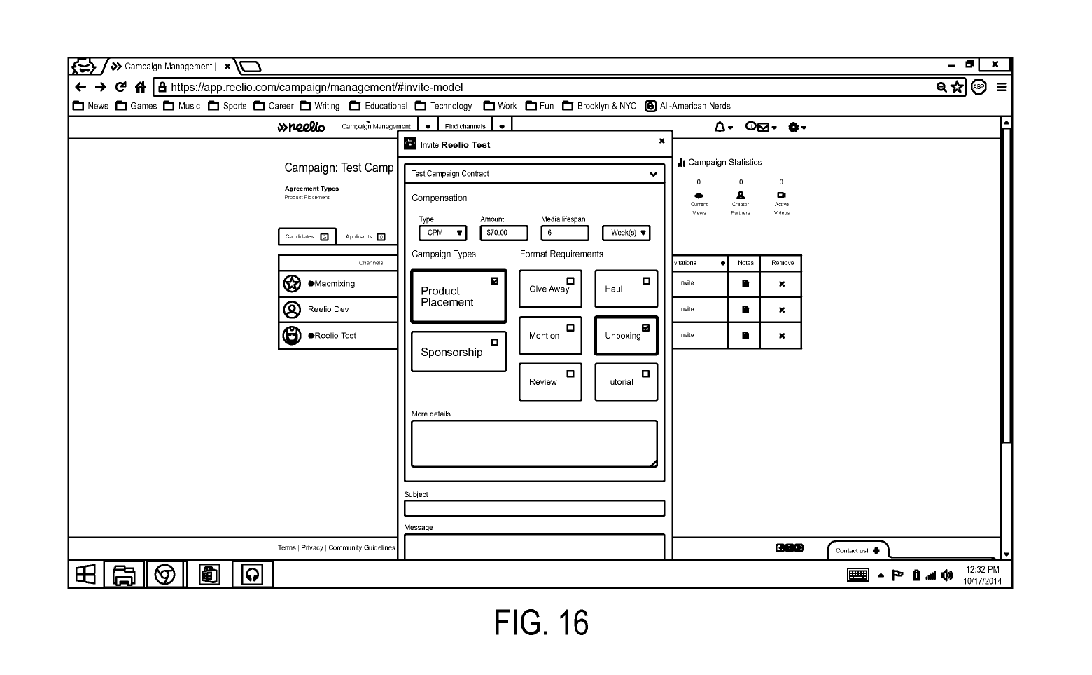

The message(s) and/or invitations sent to the content creator can also contain the user's campaign parameters and details discussed above. FIG. 16 illustrates an example user interface for contacting a content creator with campaign parameters. Accordingly, the content creator will have an understanding of what is expected of him prior to committing to preparing media content for the user.

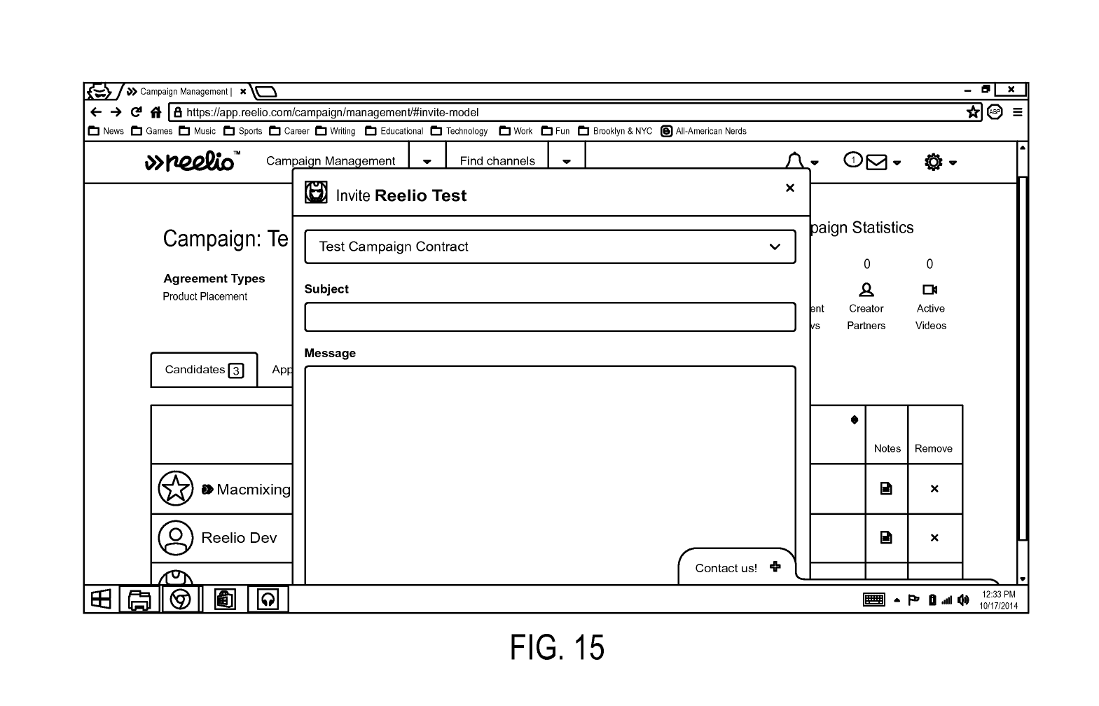

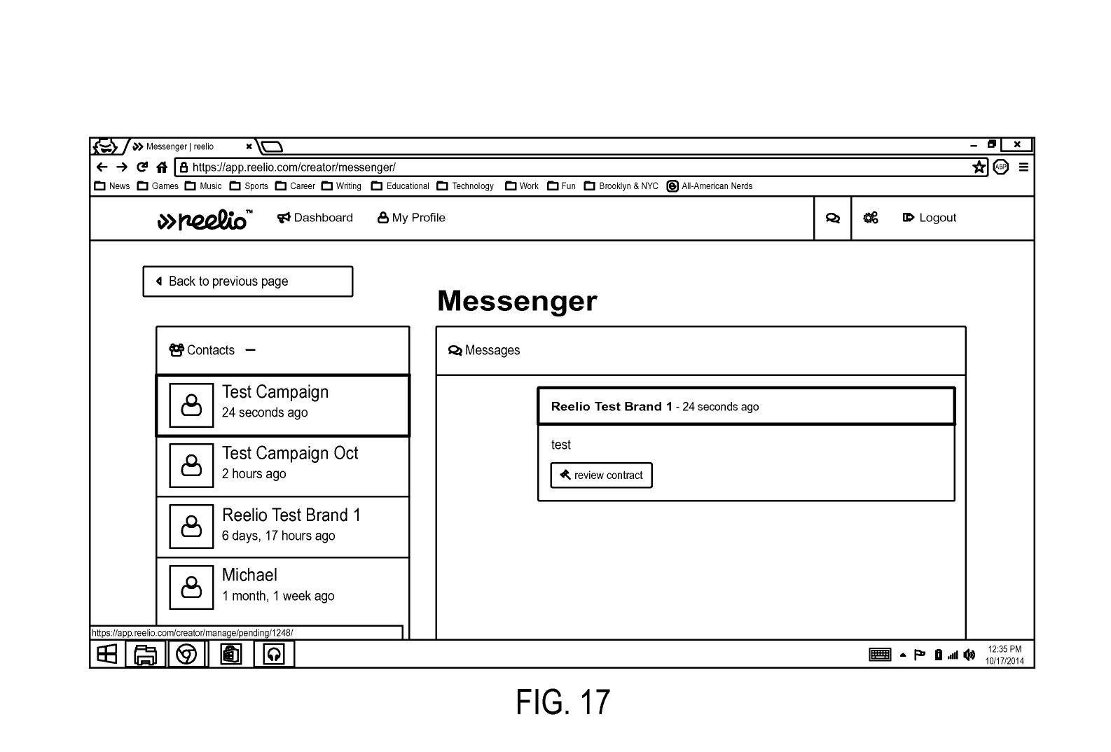

Furthermore, a contract for services under the campaign parameters can be sent to the content creator or posted to the Open Marketplace where eligible content creators may apply to produce media content under the terms of the posted contract for services as a campaign opportunity. FIG. 15 illustrates an example user interface for contacting a content creator with a contract. As previously discussed, the system can determine whether a given content creator is eligible to apply for a campaign opportunity posted in the Open Marketplace based upon the Match Score of the content creator vis-à-vis the parameters of the user's media campaign. These contracts can also be pre-defined and include, for example, the terms of service, payments, copyright ownership and digital rights management of campaign media, etc. It is also possible for a content creator to negotiate some of the terms of the contract. Such negotiation can be accomplished through the exchange of various messages between the user and the content creator through the media campaign management system among other communication methods, or through automated bid-processing or auction systems. If the contract is not reviewed or accepted by the content creator after a designated period of time, the system can automatically send message notifications to the content creator reminding him to take action. FIG. 17 illustrates an example user interface for receiving a message from a user.

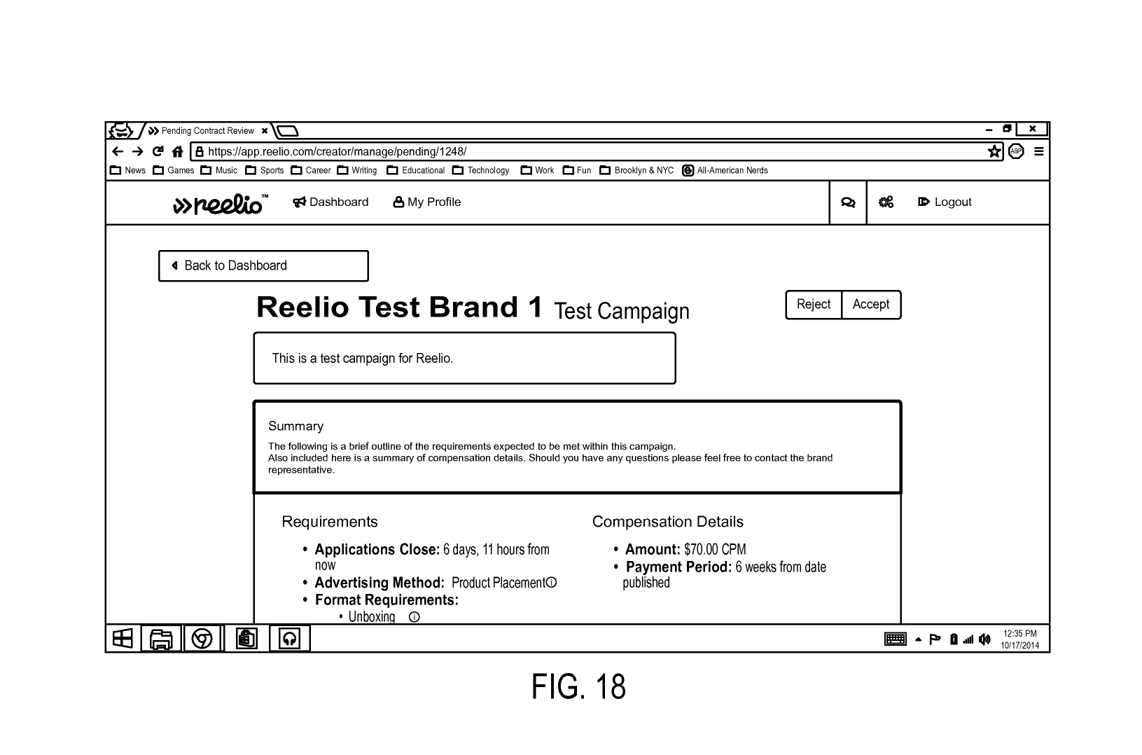

At step 104, the media campaign management system receives approval from the user selected content creator to create or use media content of the content creator. Alternatively, if the content creator has applied to a campaign opportunity posted by a user in the Open Marketplace, the user can approve or disapprove the content creator's application. The system can also receive approval from the content creator's agent or manager. In addition, the system can also receive proposals from content creators or content creators agents responding to a user's media campaign requests as discussed below. The system can receive those approvals or disapprovals in step 104 as well. The content creator can agree to create media content for the user in accordance with at least one of the user's multiple parameters for creating the media content. Such approval can be a content creator's acceptance to the terms of a service contract or that the content creator agrees to create media for a user's media campaign. FIG. 18 illustrates an example user interface for accepting or rejecting to join a media campaign. In addition, such approval from the content creator can be to join the campaign management system itself without necessarily accepting the terms of a given service contract made available through the system. When approval is received by the system from the content creator, the system's database can store all data and information related to the content creator. In addition, the media campaign management can store information related to the content creator when the content creator is added as a candidate content creator by the user. For example, the system can store keywords, YouTube URLs, Twitter data, Facebook data, and other information used to find the content creator.

Furthermore, upon receiving approval from the user selected content creator, the system can register all billing information for the content creator as well as tie the content creator into all of the system's monitoring mechanisms to track the performance of the content creator's work and any media produced by the content creator for the media campaign. By automating these recruiting and payment processes, administrative manpower and cost on the user and content creator's side is greatly reduced. Accordingly, both content creators and users are able to eliminate unnecessary and time consuming steps and instead reach their end goals sooner and cheaper.

The approval can be received from the content creator in various ways. The content creater can send a message back to the user, can join the media campaign management system, can join the user's media campaign, and/or can accept the terms of the contract. All of these ways can be automated such that the approval can be accomplished by the content creator simply by selecting or clicking a button or option. Furthermore, the system can automatically send reminder messages and notifications to users or content creators in the event that actions are required with respect to any specific steps in the relevant media campaign.

At step 105, the media campaign management system receives media content from the content creator. Additionally, prior to receipt of the media content, the system can automatically send messages or notifications to content creators reminding them to submit the media content to the media campaign management system by applicable deadline(s) as may be established by the campaign parameters. The media content received from the content creator can be media created specifically for the user's media campaign. In addition, the media content can be in accordance with at least one of the parameters of the user's media campaign. However, the media content does not have to be created after a media content creator is contacted by a user, but could have been created prior to the user contacting the media content creator.

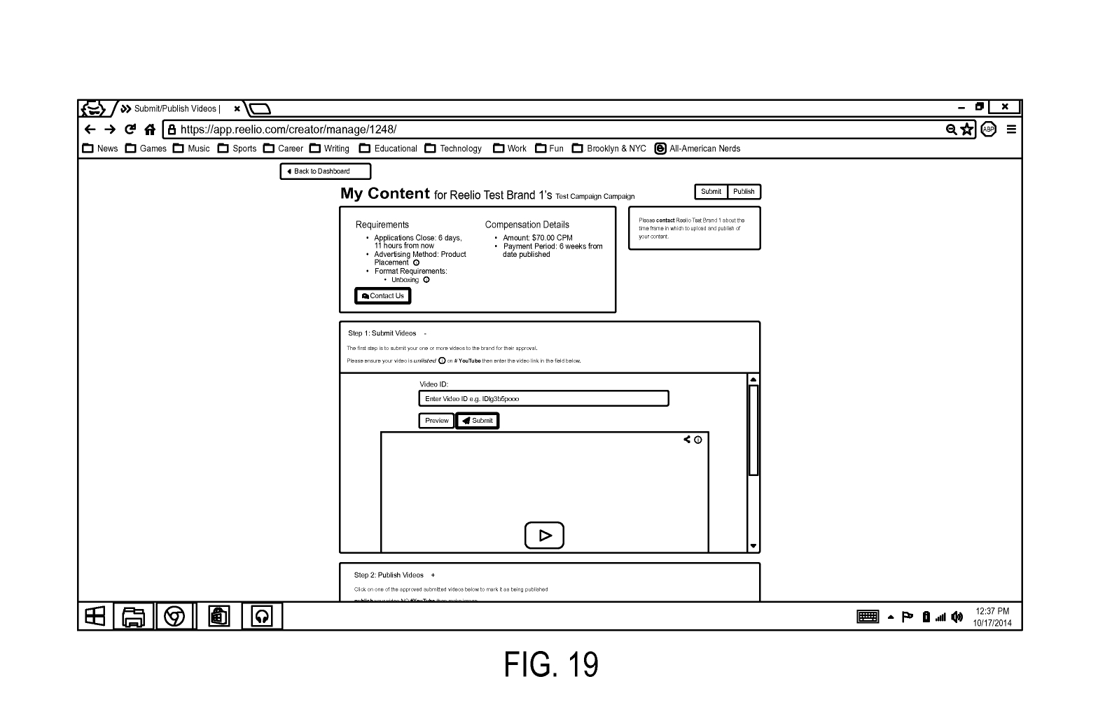

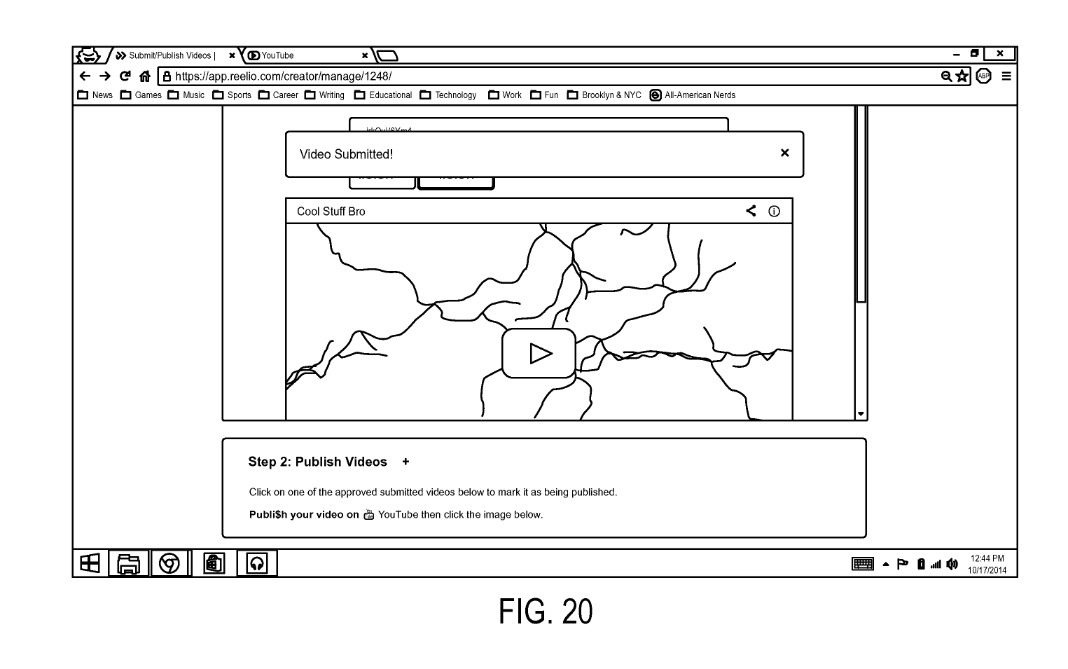

The content creator can send, upload, or post the media content to the media campaign management system. FIG. 19 illustrates an example user interface for receiving media content from the content creator. The system can also notify the content creator and/or the user when the media content has been submitted. FIG. 20 illustrates an example user interface providing notification of media content submission. The media content can then be viewed by the user in order to approve the media content before it is publically available. In addition, the content creator can send, upload, or post preliminary or unfinished versions of the media content or media content ideas to the media content management system in order for the user to review and provide feedback during the media creation process.

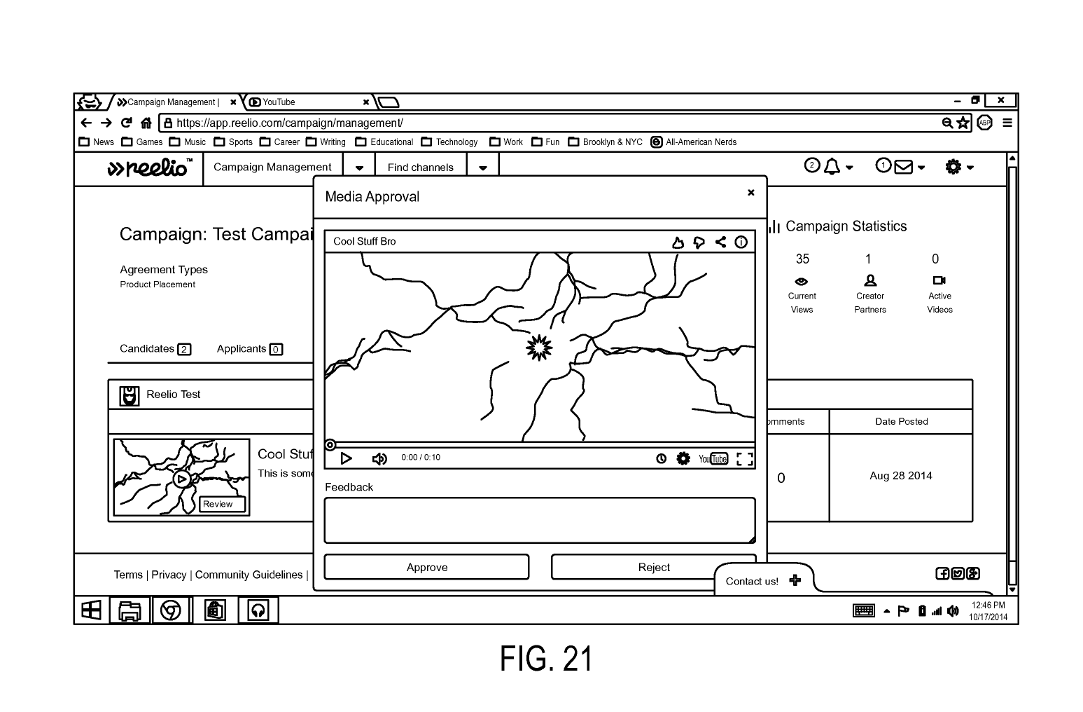

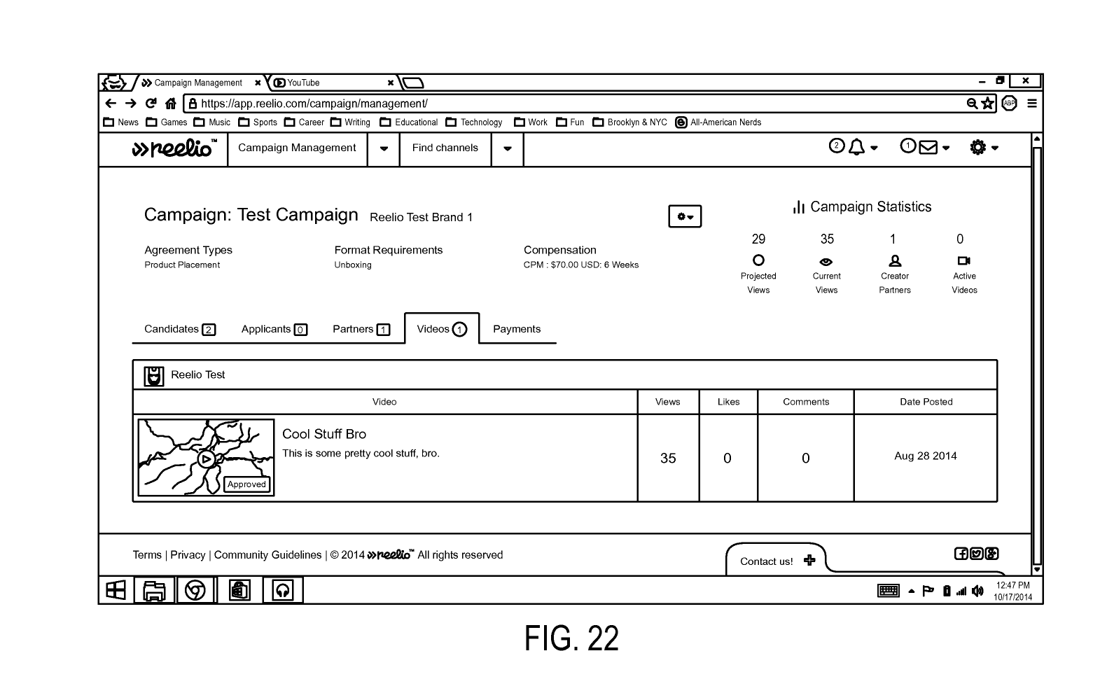

At step 106, the media campaign management system receives approval of the media content from the user. FIG. 21 illustrates an example user interface for approving media content. FIG. 22 illustrates an example user interface for displaying media content approval. Prior to approval, the user can review the media content from the content creator to determine if the media content is consistent with the user's expectations and/or parameters. In addition, the user can request that the content creator make changes to the content media and provide updated or revised versions of the media content. The user can also automatically receive messages and/or notifications when media content is submitted by a content creator for approval.

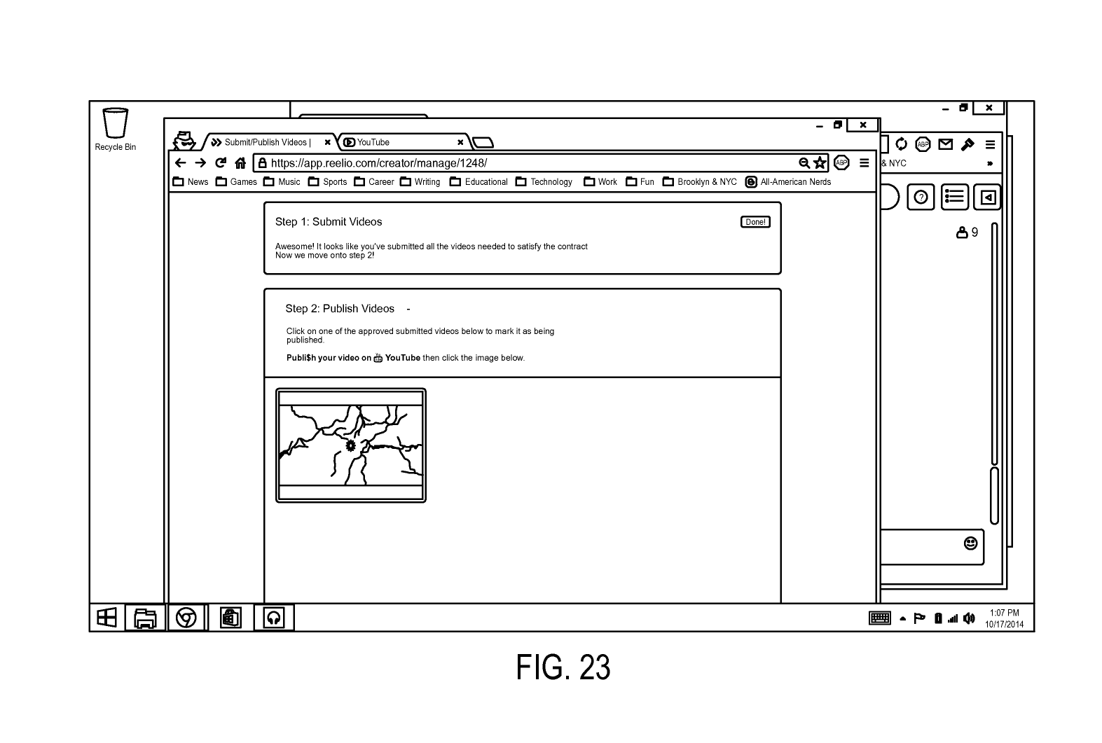

Upon approval of the media content, the user, the system, or the content creator can publish the media content. FIG. 23 illustrates an example user interface for publishing media content. The user, the system, or the content creator can upload or post the media content to any media outlet desired by the user. For example, upon approval, the media campaign management system can upload the approved media to YouTube. Such publishing can be done automatically based on a user's preferred media outlet and permissions received by the system from the user and/or content creator. In addition, the user can select additional outlets to publish the media content provided by the content creator. The system can automatically generate a unique URL to be included with the published media content. The URL can point or direct to any website specified by the user. When an audience member for the media campaign clicks on the unique URL, that audience member can be taken to the website specified by the user, but first, may temporarily land on an internal page of the system which can register this web traffic before redirecting the audience member to the user's intended destination webpage. Thus, the system can enable link tracking in connection with media campaigns in an automated manner.

In addition, the system can automatically audit media content to ensure that media content is not published until the user has approved of the media content. Furthermore, the system can automatically audit media content to ensure that the media content complies with FTC guidelines on sponsored content. For example, the system can audit a content creator's video created for a user's media campaign to ensure that the created video includes “Sponsored by [User]” in the description of their video.

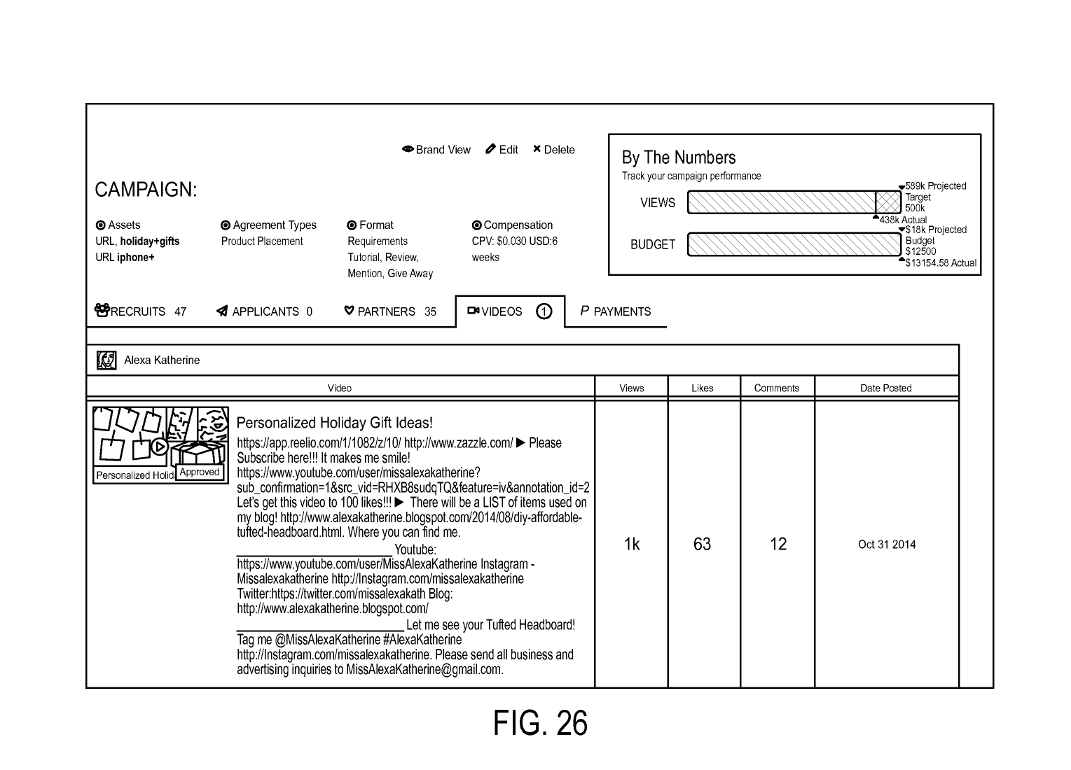

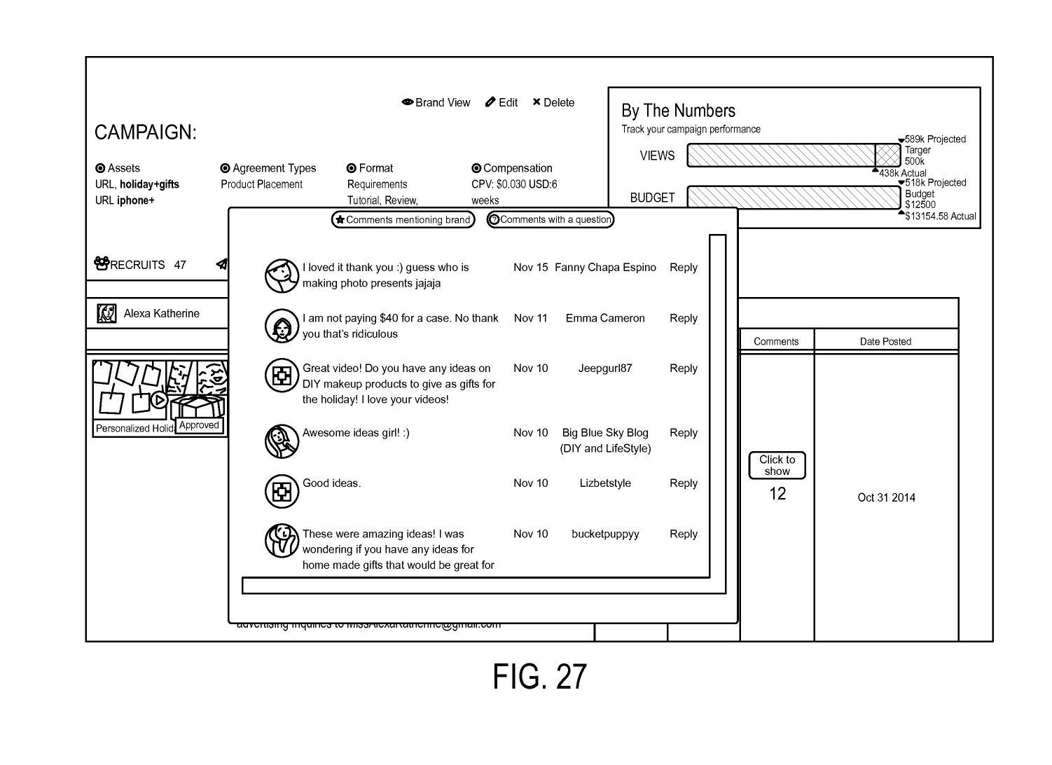

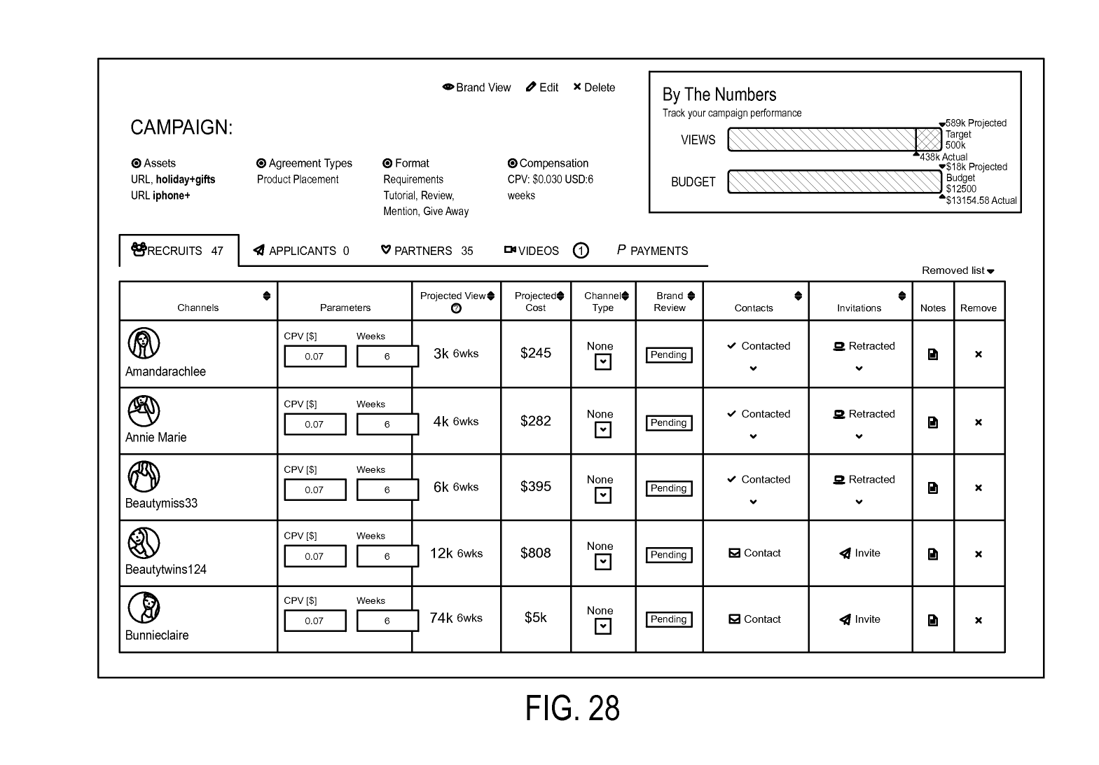

At step 107, the media campaign management system monitors and tracks the performance of the published media content. The media campaign management system can automatically monitor performance metrics of the media produced for a campaign. For example, these metrics can include views, social engagements (tweets, comments, likes, etc.), and click through rates (from the media content to the user's specified webpage(s)). FIG. 26 illustrates an example user interface displaying various media campaign performance metrics. The user can also customize which metrics it wants to keep track of as well as view these metrics in more details. FIG. 27 illustrates an example user interface displaying comments on the media content from a media campaign. The system can also keep track of the value of visitors from the media content in the campaign compared to the value of visitors from other traffic sources. In addition, these metrics can be automatically displayed to the user through customizable information dashboards of the media campaign management system. The system can also keep track of the candidates and/or recruits for a specific media campaign. For example, the system can keep track of the content creators who were contacted, applied for the media campaign, and/or were identified in the search (whether added as a candidate or not) for a content creator for the media campaign. FIG. 28 illustrates an example user interface displaying various recruits for a media campaign.

In addition, upon reaching pre-defined performance milestones and/or periods of time, the system can automatically generate performance reports and feedback to the user. Furthermore, the system can generate customizable reports based on the user's needs.

In addition to the above steps, the media campaign management system can also include a payment distribution system. The payment distribution system can automatically generate payments and invoices based on pre-defined criteria. For example, the agreement between the user and content creator can include payment terms. Accordingly, the system can generate a payment invoice whenever the terms in the contract are met or on a period basis over the course of the agreement. The payment terms, for example, can state that an initial payment is due upon some initial milestone, such as verification of created media content or a media content uploaded to the media campaign management system. Other payment terms can be performance based. These can include $/view, $/repost, $/non-unique view, among many others. The media campaign management system can automatically notify the user and/or content creator every time a payment is qualified and/or distributed.

Furthermore, since the media campaign management system can contain the billing information for the user and the content creator, the user can pay a content creator by simply clicking or selecting a button or option, or by allowing the system to automatically calculate and process payments when appropriate. Additionally, the system can require that content creators complete required tax forms (e.g., IRS Form W9) prior to distributing payments to content creators and compile and store those forms automatically. Such an automated and integrated system can free up significant administrative overhead that exists with current methods of paying for services rendered.

The media campaign management system can also generate periodic or customizable reports that detail various aspects of the user's media campaign's financial performance including profitability as a function of time, resources, overhead, etc.

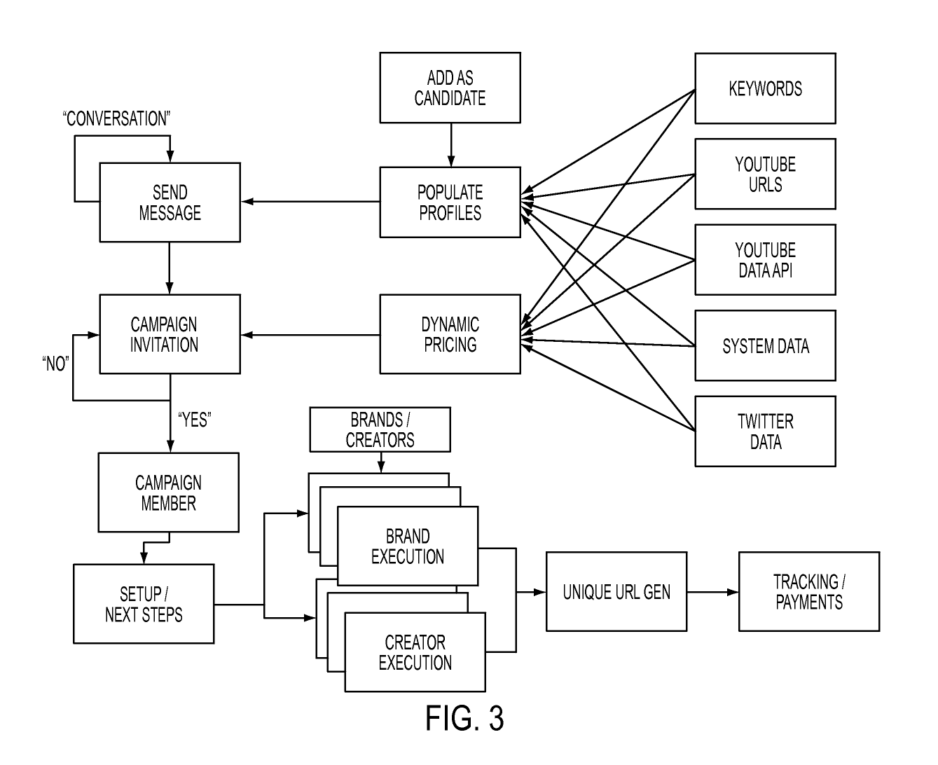

FIG. 3 illustrates an example of a media creation process described above and further detailed below within an embodiment of the media development and management system.

The system can automatically calculate cost for each transaction within the system. By calculating the projected viewership for a given creator's media content, the system can predict an overall cost for the media content and offer an alternative of a fixed compensation (guaranteed payment) or performance-based compensation. Additionally, the media campaign development and management system can adjust the price based on the other Base Scores built on the user's campaign and the content creator. This could be based on any of the comparisons the system uses to judge how appropriate the match is. For example, the higher the relevancy of the creator's content to the user's campaign or the greater the audience overlap between the creator's audience and the intended audience for the user's campaign, the more effective the media content is likely to be for the campaign, and thus the higher the compensation. The pricing system can also take into account the time-sensitive trends in all of these attributes. For example, if the median views for a content creator has been increasing by 10% for every successive media content posted, the price would likely be higher based on that trend of increasing performance. Additionally, the pricing system can take into account factors that are not directly related to the performance, relevance, or audience of the media content, but rather factors more related to the execution of the media campaign (e.g., brand friendliness). For example, the easier a creator is to work with, the higher potential compensation that creator would be able to likely command. In contrast, a creator who is difficult to work with may be penalized in compensation. Various factors can be used to quantify this, including, but not limited to, message response alacrity, flexibility, likelihood to complete the contract, timeliness in meeting deadlines, ability to respond to criticism and/or feedback. All of these factors can feed into the pricing system, allowing the system to identify trends in outcome and satisfaction from both users and content creators, thereby continuously changing the pricing factor weightings to optimize the experience and satisfaction for both content creators and users.

Additionally, there are many complications around integrating multiple different user types into an ecosystem. The pricing system can also include dynamic pricing structures that include multiple stakeholders besides just the users and the content creators. As management and representation entities enter the system, they will demand fees as part of the transactions. The pricing system can generate “market” prices that maximize transparency and value across the sum of the entities. For example, a content creator may be represented by a Talent Agency or a Multi-Channel Network (MCN), which may demand a percentage of the transaction fee as a result of their representation or services. Similarly, the user may be represented by an Agency (Creative or Programmatic) that is coordinating larger campaign or advertising expenditures. Each of these fees may be negotiable or dynamic based on the particular situation and balance of leverage for that specific campaign. Thus, the system can seek the optimal balance of fees based on maximizing throughput in the marketplace, thereby benefiting all parties involved by increasing the volume of their work while maintaining acceptable fees for all. This can be done through a varying combination of machine learning, statistical analysis, predictive algorithms, bidding systems, and other methods. The system can be built around quantifying and analyzing the existing transaction structure and the influence of the ranking/scoring system in identifying how important/desirable each party is in the transaction, which can form the basis for the pricing weights.

Based on data collected from completed media campaigns, the media campaign management system can correlate the performance metrics of individual content creators to the amount of compensation those creators require to produce media content. Accordingly, the media campaign management system can include a dynamic price-matching system (described above) that can selectively present to users only those content creators who are likely to accept the user's proposed terms of services (which include payment terms), and similarly content creators and users of the system respectively can each see customized pricing and compensation offers based upon how well-matched they are for a specific media campaign. Thus, the pricing and compensation offers made to content creators participating in a campaign can be automatically adjusted and customized depending upon the values of the content creator's various Base Scores and the Match Score of a content creator with respect to the parameters of a specific media campaign initiated by the user.

As previously discussed, besides a user searching for a content creator to create media content for the user's media campaign, the media campaign management system can also allow a content creator to search for an entity in need of the content creator's services. For example, the system can allow a content creator to apply for and/or bid to participate in a user's media campaign. These interactions can be stored by the system and can be used to improve the calculation of Base Scores and Match Scores and to further refine the dynamic price-matching system across all media campaigns initiated on the system. The system can also automatically filter what content creators can apply for a user's media campaign based on various criteria, including, but not limited to, the values of a content creator's Base and Match Score with respect to the parameters of the user's media campaign.

In addition to the services described above, the system can also manage the interaction and bid-response cycle between many of the different user types within the system. Generally, based on the concept of creating and distributing a Request for Proposal (“RFP”), to which third-party vendor responses can be collected and analyzed, the system can enable the automated distribution of a standardized RFP in electronic format by one user to other users of the system. This RFP distribution can be initiated through the system by a user or a user's agent (that is, an individual or entity responsible for administering media content campaigns for multiple brands, e.g., an advertising agency) and then can be delivered to content creator's agent (that is, talent agencies or Multi-Channel Networks, which often represent multiple media content creators). The content creator agents can respond to this generated RFP through standardized inputs and responses that streamline the bid-response cycle and can enable users or user's agents to efficiently compare and analyze responses submitted by various content creators or content creator agents. All users involved can have direct messaging capabilities to facilitate communications and negotiation throughout the bid-response cycle.

The process for managing the interaction and bid-response cycle between user or user agents and content creators or content creator agents can start with the user or user agent defining specific parameters for a media content campaign outlined in the RFP (“RFP parameters”). These parameters can include those campaign parameters discussed above including total budget or compensation amount for the campaign, campaign launch and completion dates, video type and format requirements, geographic location target of the campaign, demographic targets for the campaign, user product details to be featured in the media content for the campaign, and creative briefs for the desired media content. Based upon these parameters, the system can generate a standardized RFP that is distributed (electronically) to one or more content creators or content creator agents that can be either specifically selected by the user or user agent, or identified automatically based upon an analysis and matching of the RFP parameters to the Scores (as described above) of the content creators associated with specific content creator agents (these associations can be previously established from data existing in and collected by the system). Content creator agents receiving these RFPs can review the RFP parameters and can submit specific proposals that will satisfy those parameters, for example, by identifying such information as the media content creators the content creator agent represents, identifying the content creators who are specifically available to satisfy the RFP parameters, specifying the fees associated with each such content creator or the total fees across multiple content creators, indicating statistical attributes of each content creator's audience (e.g., number of subscribers, views, followers, etc.) and/or demographic information concerning the same (e.g., age, sex, location), guaranteeing a specific number of impressions based upon an established cost per view of proposed media content, proposing specific creative concepts with reference to the RFP parameters. All information submitted by a content creator agent can be collected by the system in a standardized RFP electronic format.

After receiving specific proposals from multiple content creator agents, the system can enable the user or user agent to review, analyze, and evaluate the various proposals. The system can enable the user or user agent to compare each proposal simultaneously, allowing an “apples to apples” comparison across multiple proposals from different content creator agents. The system can further allow the user or user agent to optimize their selection of proposals, or some cross section of those proposals, in an automated fashion by allowing the user or user agent to assign relative importance to each distinct RFP parameters (e.g., budget, launch, and completion dates, video type and format, geographic target, demographic target, etc.). This optimization can be achieved through a single user input (e.g., a “click”) that causes the various content creator agent proposals (or cross sections thereof) to be ranked or recommended with reference to the relative weight given by the user or user agent to each RFP parameter. Additionally, the system's ability to establish individual pricing levels for specific media content creators can also be used by the system to analyze and rank proposals on cost and to provide the user or user agent with pricing recommendations that may guide subsequent negotiations between the users. Once the user or user agent has determined which content creator agent (and associated content creators) it wishes to include in the campaign, the system can enable the user or user agent to rely on standard legal agreements generated by the system or to upload custom legal agreements belonging to the user or user agent and to have those agreements (electronically) delivered to and executed by all users.

An exemplary hardware architecture for implementing certain embodiments is described. Specifically, one embodiment can include a computer communicatively coupled to a network (e.g., the Internet). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc), or the like. In some embodiments, the computer has access to at least one database.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The functionalities and processes described herein can be implemented in suitable computer-executable instructions. The computer-executable instructions may be stored as soft-ware code components or modules on one or more computer readable media. Examples of computer readable media include, but are not limited to, non-volatile memories, volatile memories, DASD arrays, magnetic tapes, floppy diskettes, hard drives, optical storage devices, or any other appropriate computer-readable medium or storage device, etc. In one exemplary embodiment of the disclosure, the computer-executable instructions may include lines of compiled C++, Java, HTML, or any other programming or scripting code.

Additionally, the functions of the present disclosure may be implemented on one computer or shared/distributed among two or more computers in or across a network. Communications between computers implementing embodiments of the disclosure can be accomplished using any electronic, optical, radio frequency signals, or other suitable methods and tools of communication in compliance with known network protocols.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. An online system configured to:
receive multiple parameters from a user for creating media content;
identify media content creators for creating the media content, wherein an audience of the content creators aligns with a target audience for the media content;
contact at least one of the identified media content creators selected by the user;
receive approval from the at least one contacted media content creator to create the media content in accordance with at least one of the received parameters for creating the media content;
receive the media content created by the at least one contacted media content creator;
receive approval from the user to publish the created media content; and
monitor the performance of the published media content.

2. The system of claim 1, wherein identifying media content creators comprises determining a number of views of media content previously produced by the media content creators.

3. The system of claim 1, wherein the system is further configured to generate payment invoices to the content creator after the created media content has been received.

4. The system of claim 1, wherein identifying media content creators comprises:
receiving user input comprising keywords, YouTube URLs, or twitter handles; and
identifying media content creators based on the user input.

5. The system of claim 4, wherein identifying media content creators based on the user input comprises determining the overlap between the user input and media content creators' tweets.

6. The system of claim 4, wherein after the system identifies media content creators based on the user input, the system is configured to:
receive user selection of at least one the identified media content creators; and
identify additional media content creators similar to the user selected media content creator.

7. The system of claim 1, wherein at least one of the multiple parameters for creating media content comprises a type of media format for the media content.

8. The system of claim 1, wherein contacting at least one of the identified media content creators comprises sending an invitation to the at least one of the identified media content creators to join the online system.

9. The system of claim 8, wherein the invitation comprises at least one of the multiple parameters for creating the media content.

10. The system of claim 1, wherein the system is configured to publish the media content to YouTube.

11. A computer-implemented method comprising:
receiving multiple parameters for creating media content;
identifying media content creators for creating the media content, wherein an audience of the content creator aligns with a target audience for the media content;
contacting at least one of the identified media content creators;
receiving approval from the at least one contacted media content creator to create the media content in accordance with at least one of the received parameters for creating the media content;
receiving the media content created by the at least one contacted media content creator;
publishing the created media content; and
monitoring the performance of the published media content.

12. The method of claim 11, wherein identifying media content creators comprises determining a number of views of media content previously produced by the media content creators.

13. The method of claim 11, further comprising generating payment invoices to the content creator after the created media content has been received.

14. The method of claim 11, wherein identifying media content creators comprises:
receiving user input comprising keywords, YouTube URLs, or twitter handles; and
identifying media content creators based on the user input.

15. The method of claim 14, wherein identifying media content creators based on the user input comprises determining the overlap between the user input and media content creators' tweets.

16. The method of claim 14, wherein after identifying media content creators based on the user input, the method further comprises:
receiving user selection of at least one the identified media content creators; and
identifying additional media content creators similar to the user selected media content creator.

17. The method of claim 11, wherein at least one of the multiple parameters for creating media content comprises a type of media format for the media content.

18. The method of claim 11, wherein contacting at least one of the identified media content creators comprises sending an invitation comprising at least one of the multiple parameters for creating the media content.

19. The method of claim 11, wherein the system is configured to publish the video to YouTube.

20. An online system configured to:
receive multiple parameters from a user for creating an advertising video;
identify YouTube content creators for creating the advertising video, wherein an audience of the YouTube content creator aligns with a target audience for the advertising video;
contact at least one of the identified YouTube content creators selected by the user;
receive approval from the at least one contacted YouTube content creator to create the advertising video in accordance with at least one of the received parameters for creating the advertising video;
receive the advertising video created by the at least one contacted YouTube content creator;
receive approval from the user to publish the created advertising video to YouTube; and
monitor the performance of the published advertising video.
